(19) United States
(12) Patent Application Publication
(10) Pub. No.: US 2010/0061642 A1
(43) Pub. Date: Mar. 11, 2010

(54) PREDICTION COEFFICIENT OPERATION DEVICE AND METHOD, IMAGE DATA OPERATION DEVICE AND METHOD, PROGRAM, AND RECORDING MEDIUM

(75) Inventors: Tetsujiro Kondo, Tokyo (JP); Tsutomu Watanabe, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Minato-ku (JP)

(21) Appl. No.: 12/441,404

(22) PCT Filed: Sep. 28, 2007
(86) PCT No.: PCT/JP07/68924

§ 371 Date: Mar. 16, 2009

(30) Foreign Application Priority Data
Sep. 28, 2006 (JP) 2006-264020
Sep. 19, 2007 (JP) 2007-242558

(51) Int. Cl. G06K 9/36; G06K 9/40; G06K 9/62

(52) U.S. Cl. 382/224; 382/264; 382/238

(57) ABSTRACT

The present invention relates to a prediction coefficient computing device and method, an image data computing device and method, a program, and a recording medium which make it possible to accurately correct blurring of an image. A blur adding unit 11 adds blur to parent image data on the basis of blur data of a blur model to generate student image data. A tap constructing unit 17 constructs an image prediction tap from the student image data. A prediction coefficient computing unit 18 computes a prediction coefficient for generating image data corresponding to the parent image data, from image data corresponding to the student image data, on the basis of the parent image data and the image prediction tap. The present invention can be applied to an image processing device.

### TECHNICAL FIELD

The present invention relates to a prediction coefficient computing device and method, an image data computing device and method, a program, and a recording medium, in particular, a prediction coefficient computing device and method, an image data computing device and method, a program, and a recording medium which make it possible to correct blurring of an image more accurately.

Also, the present invention relates to a prediction coefficient computing device and method, an image data computing device and method, a program, and a recording medium which make it possible to generate an image that fluctuates naturally, or to compute prediction coefficients for the image.

### BACKGROUND ART

When an image is captured by an autofocus function with a digital still camera, in some cases, the digital still camera is focused not on a subject as the foreground which is intended to be captured but on the background, with the result that the image of the intended subject becomes blurred. For example, FIG. 1 shows an example of such an image. Since the focus is on the background, the image of a flower in the foreground which is an intended subject is blurred out of focus.

The present applicant has previously proposed compensating for such blur (for example, Patent Document 1). In the previous proposal, features of an image are detected, and a model equation for computing an image compensated for blurring is changed in accordance with the features of the image. This enables faithful compensation at the edge parts or detailed parts.

Also, it is conceivable to learn many images, compute prediction coefficients by a classification adaptive process, and compensate for blurring by using the prediction coefficients.

Further, although not concerning blurring, Patent Document 2 discloses generating an image in which the image of an object reflected on the water surface is made to fluctuate in accordance with the fluctuation of the water surface.

Patent Document 1: Japanese Unexamined Patent Application Publication No. 2005-63097

Patent Document 2: Japanese Unexamined Patent Application Publication No. 2006-318388

### DISCLOSURE OF INVENTION

### Problems to be Solved by the Invention

However, with the proposal of Patent Document 1, it has been difficult to correct blurring of an image accurately pixel by pixel.

Also, to correct blurring of an image accurately by a classification adaptive process, it is necessary to accurately separate an image into classes, such as by classifying in-focus pixels and out-of-focus pixels into different classes. However, it is difficult to achieve classification in which in-focus pixels and out-of-focus pixels are classified into different classes solely from a normal image. That is, FIG. 2 is a view in which pixels in one class into which many of pixels that constitute the in-focus background (the scenery excluding the flower and leaves) are classified are represented as 1, and pixels classified into other classes are represented as 0. As shown in the drawing, a large number of pixels that constitute the out-of-focus foreground (the flower and leaves) are classified into a class into which many of pixels that constitute the in-focus background are classified. This means that accurate blur compensation is difficult even when focus is compensated for by using prediction coefficients that are obtained by classification solely from a normal image.

Also, since the technique according to Patent Document 2 generates an image reflected on the water surface, an image generated by the technique is a distorted image. Therefore, it has been difficult to generate an image whose relatively detailed original state can be recognized as it is, and has an effect of fluctuating naturally due to variations in the temperature or humidity of the ambient air, or the like, such as one observed when a person sees an object in the air from afar.

The present invention has been made in view of the above-mentioned circumstances, and makes it possible to accurately correct blurring of an image.

Also, the present invention makes it possible to generate an image that fluctuates naturally.

### Means for Solving the Problems

An aspect of the present invention relates to a prediction coefficient computing device including: blur adding means for adding blur to parent image data on the basis of blur data of a blur model to generate student image data; image prediction tap constructing means for constructing an image prediction tap from the student image data; and prediction coefficient computing means for computing a prediction coefficient for generating image data corresponding to the parent image data, from image data corresponding to the student image data, on the basis of the parent image data and the image prediction tap.

The prediction coefficient computing device can further include: image class tap constructing means for constructing an image class tap from the student image data; blur data class tap constructing means for constructing a blur data class tap from the blur data; and classification means for classifying a class of the student image data on the basis of the image class tap and the blur data class tap, and the prediction coefficient computing means can further compute the prediction coefficient for each the classified class.

The blur adding means can add blur to the parent image data on the basis of a characteristic according to a blur parameter specified by a user, and the prediction coefficient computing means can further compute the prediction coefficient for each the blur parameter.

The prediction coefficient computing device can further include blur noise adding means for adding noise to the blur data on the basis of a characteristic according to a noise parameter specified by the user, the blur adding means can add blur to the parent image data on the basis of the blur data to which noise has been added, the blur data class tap constructing means can construct the blur data class tap from the blur data to which noise has been added, and the prediction coefficient computing means can further compute the prediction coefficient for each the blur parameter.

The prediction coefficient computing device can further include data scaling means for scaling the blur data on the basis of a scaling parameter specified by the user, the blur noise adding means can add noise to the scaled blur data, and the prediction coefficient computing means can further compute the prediction coefficient for each the scaling parameter.

The prediction coefficient computing device can further include image noise adding means for adding noise to the student image data on the basis of a characteristic according to an image noise parameter specified by the user, the image class tap constructing means can construct the image class tap from the student image data to which noise has been added, the image prediction tap constructing means can construct the image prediction tap from the student image data to which noise has been added, and the prediction coefficient computing means can further compute the prediction coefficient for each the image noise parameter.

The prediction coefficient computing device can further include image scaling means for scaling the student image data on the basis of a scaling parameter specified by the user, the image noise adding means can add noise to the scaled student image data, and the prediction coefficient computing means can further compute the prediction coefficient for each the scaling parameter.

The blur data can further include the blur data prediction tap constructing means for constructing the blur data prediction tap from the blur data, and the prediction coefficient computing means can compute, for each the classified class, a prediction coefficient for generating image data corresponding to the student image data, on the basis of the parent image data, the image prediction tap, and the blur data prediction tap.

The blur data can be configured as data to which noise is added.

An aspect of the present invention also relates to a prediction coefficient computing method for a prediction coefficient computing device that computes a prediction coefficient, including: adding blur to parent image data on the basis of blur data of a blur model to generate student image data, by blur adding means; constructing an image prediction tap from the student image data, by image prediction tap constructing means; and computing a prediction coefficient for generating image data corresponding to the parent image data, from image data corresponding to the student image data, on the basis of the parent image data and the image prediction tap, by prediction coefficient computing means.

Further, an aspect of the present invention relates to a program for causing a computer to execute processing including: a blur adding step of adding blur to parent image data on the basis of blur data of a blur model to generate student image data; an image prediction tap constructing step of constructing an image prediction tap from the student image data; and a prediction coefficient computing step of computing a prediction coefficient for generating image data corresponding to the parent image data, from image data corresponding to the student image data, on the basis of the parent image data and the image prediction tap.

This program can be recorded on a recording medium.

Another aspect of the present invention relates to an image data computing device including: prediction coefficient providing means for providing a prediction coefficient corresponding to a parameter that is specified by a user and is a parameter related to blurring of image data; image prediction tap constructing means for constructing an image prediction tap from the image data; and image data computing means for computing image data that is corrected for blurring, by applying the image prediction tap and the provided prediction coefficient to a predictive computing equation.

The image data computing device can further include: image class tap constructing means for constructing an image class tap from the image data; blur data class tap constructing means for constructing a blur data class tap from blur data; and classification means for classifying a class of the image data on the basis of the image class tap and the blur data class tap, and the prediction coefficient providing means can further provide the prediction coefficient corresponding to the classified class.

The prediction coefficient providing means can provide the prediction coefficient on the basis of a blur parameter that defines a characteristic of blur, a parameter that defines a class based on noise contained in the image data, a parameter that defines a class based on noise contained in the blur data, or motion information.

The prediction coefficient providing means can further provide the prediction coefficient on the basis of a parameter that is specified by a user and is a parameter that defines a class based on scaling of the image data or the blur data.

The blur data can further include blur data prediction tap constructing means for constructing the blur data prediction tap from the blur data, and the image data computing means can compute image data that is corrected for blurring, by applying the image prediction tap, the blur data prediction tap, and the provided prediction coefficient to the predictive computing equation.

Another aspect of the present invention also relates to an image data computing method for an image data computing device that computes image data, including: providing a prediction coefficient corresponding to a parameter that is specified by a user and is a parameter related to blurring of the image data, by prediction coefficient providing means; constructing an image prediction tap from the image data by image prediction tap constructing means; and computing image data that is corrected for blurring, by applying the image prediction tap and the provided prediction coefficient to a predictive computing equation, by image data computing means.

Further, another aspect of the present invention relates to a program for causing a computer to execute processing including: a prediction coefficient providing step of providing a prediction coefficient corresponding to a parameter that is specified by a user, and is a parameter related to blurring of image data; an image prediction tap constructing step of constructing an image prediction tap from the image data; and an image data computing step of computing image data that is corrected for blurring, by applying the image prediction tap and the provided prediction coefficient to a predictive computing equation.

This program can be recorded on a recording medium.

Still another aspect of the present invention relates to an image data computing device including: parameter acquiring means for acquiring a parameter; noise computing means for computing noise of blur of a blur model on the basis of the acquired parameter; and image data computing means for computing image data to which the noise of the blur model is added.

The image data computing means can compute the image data by adding noise to a point spread function of blur.

The noise computing means can compute depth data with noise added to depth data, and the image data computing means can add noise to the point spread function of blur on the basis of the depth data to which noise has been added.

The noise computing means can compute a deviation, phase, or sharpness of the point spread function of blur, or noise as a composite thereof.

The noise computing means can compute a motion amount, a direction of motion, or noise as a composite thereof.

In a case of adding noise to the direction of motion, the noise computing means can add noise to a position of an interpolated pixel at the time of computing a pixel value of the interpolated pixel in the direction of motion.

The image data computing device can further include setting means for setting a processing area, and the image data computing means can add noise with respect to image data in the set processing area.

Still another aspect of the present invention also relates to an image data computing method for an image data computing device that computes image data, including: acquiring a parameter by parameter acquiring means; computing noise of blur of a blur model on the basis of the acquired parameter, by noise computing means; and computing image data to which the noise of the blur model is added, by image data computing means.

Further, another aspect of the present invention relates to a program for causing a computer to execute processing including: a parameter acquiring step of acquiring a parameter; a noise computing step of computing noise of blur of a blur model, on the basis of the acquired parameter; and an image data computing step of computing image data to which the noise of the blur model is added.

This program can be recorded on a recording medium.

In an aspect of the present invention, blur adding means adds blur to parent image data on the basis of blur data of a blur model to generate student image data, image prediction tap constructing means constructs an image prediction tap from the student image data, and prediction coefficient computing means computes a prediction coefficient for generating image data corresponding to the parent image data, from image data corresponding to the student image data, on the basis of the parent image data and the image prediction tap.

In another aspect of the present invention, prediction coefficient providing means provides a prediction coefficient corresponding to a parameter that is specified by a user and is a parameter related to blurring of image data, image prediction tap constructing means constructs an image prediction tap from the image data, and image data computing means computes image data that is corrected for blurring, by applying the image prediction tap and the provided prediction coefficient to a predictive computing equation.

In still another aspect of the present invention, parameter acquiring means acquires a parameter, noise computing means computes noise of blur of a blur model on the basis of the acquired parameter, and image data computing means computes image data to which the noise of the blur model is added.

### ADVANTAGEOUS EFFECTS

As described above, according to an aspect of the present invention, it is possible to correct blurring of an image accurately.

In particular, in a classification process, it is possible to prevent a situation where an image that is blurred and an image that is not blurred are classified into the same class, which makes it difficult to accurately correct blurring of an image.

Also, according to another aspect of the present invention, it is possible to generate an image that fluctuates naturally.

### BRIEF DESCRIPTION OF DRAWINGS

FIG. 1 is a view showing an example of a captured image.

FIG. 2 is a view showing the result of classification of the image in FIG. 1.

FIG. 3 is a block diagram showing the configuration of an embodiment of a learning device to which the present invention is applied.

FIG. 4 is a diagram illustrating addition of blur.

FIG. 5 is another diagram illustrating addition of blur.

FIG. 6 is a graph representing functions of the characteristics of blur.

FIG. 7 is a diagram illustrating a method of adding noise.

FIG. 8 is a flowchart illustrating a learning process by the learning device in FIG. 3.

FIG. 9 is a block diagram showing the configuration of an embodiment of a prediction device to which the present invention is applied.

FIG. 10 is a flowchart illustrating a prediction process by the prediction device in FIG. 9.

FIG. 11 is a block diagram showing the configuration of another embodiment of a learning device.

FIG. 12 is a flowchart illustrating a learning process by the learning device in FIG. 11.

FIG. 13 is a block diagram showing the configuration of another embodiment of a prediction device.

FIG. 14 is a block diagram showing the configuration of still another embodiment of a learning device.

FIG. 15 is a flowchart illustrating a learning process by the learning device in FIG. 14.

FIG. 16 is a block diagram showing the configuration of still another embodiment of a learning device.

FIG. 17 is a flowchart illustrating a learning process by the learning device in FIG. 16.

FIG. 18 is a block diagram showing the configuration of still another embodiment of a prediction device.

FIG. 19 is a flowchart illustrating a prediction process in FIG. 18.

FIG. 20 is a block diagram showing the configuration of an embodiment of an image generating device.

FIG. 21 is a block diagram showing the configuration of another embodiment of an image generating device.

FIG. 22 is a block diagram showing the functional configuration of an embodiment of a noise adding unit in FIG. 20.

FIG. 23 is a block diagram showing the functional configuration of an embodiment of a blur adding unit in FIG. 20.

FIG. 24 is a flowchart illustrating the process of generating an image with out-of-focus blur noise based on distance.

FIG. 25 is a diagram illustrating an image generating process.

FIG. 26 is a diagram showing functions.

FIG. 27 is a flowchart illustrating the process of generating an image with out-of-focus blur noise based on deviation.

FIG. 28 is a flowchart illustrating the process of generating an image with out-of-focus blur noise based on phase.

FIG. 29 is a diagram illustrating a phase shift of a function.

FIG. 30 is a diagram showing functions.

FIG. 31 is a flowchart illustrating the process of generating an image with out-of-focus blur noise based on sharpness.

FIG. 32 is a diagram showing functions.

FIG. 33 is a diagram illustrating image capture by a sensor.

FIG. 34 is a diagram illustrating the arrangement of pixels.

FIG. 35 is a diagram illustrating the operation of a detection element.

FIG. 36 is a diagram of a model in which the pixel values of pixels aligned adjacent to each other are expanded in the time direction.

FIG. 37 is a diagram of a model in which pixel values are expanded in the time direction, and a period corresponding to a shutter time is split.

FIG. 38 is a diagram of a model in which pixel values are expanded in the time direction, and a period corresponding to a shutter time is split.

FIG. 39 is a diagram of a model in which pixel values are expanded in the time direction, and a period corresponding to a shutter time is split.

FIG. 40 is a flowchart illustrating the process of generating an image with motion blur noise based on motion amount.

FIG. 41 is a diagram illustrating interpolated pixels.

FIG. 42 is a diagram illustrating a method of computing an interpolated pixel.

FIG. 43 is a flowchart illustrating the process of generating an image with motion blur noise based on angle.

FIG. 44 is a block diagram showing the configuration of another embodiment of a prediction device.

FIG. 45 is a block diagram showing the configuration of still another embodiment of a prediction device.

FIG. 46 is a block diagram showing the configuration of an embodiment of a computer to which the present invention is applied.

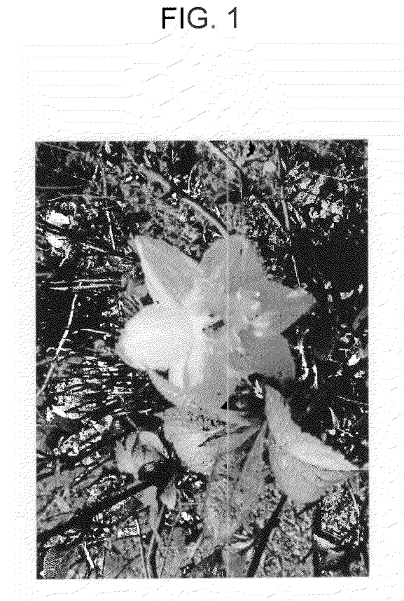

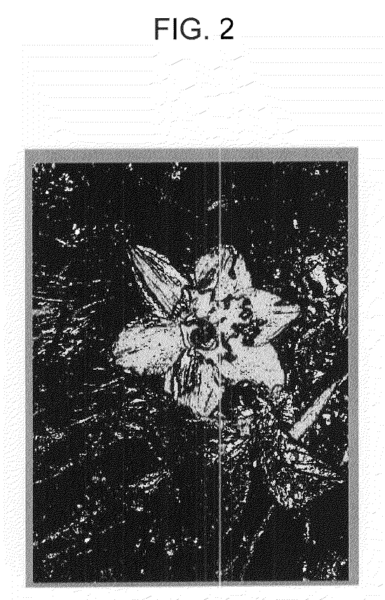

### EXPLANATION OF REFERENCE NUMERALS

1 learning device, 11 blur adding unit, 12, 13 noise adding unit, 14, 15 tap constructing unit, 16 classification unit, 17 tap constructing unit, 18 prediction coefficient computing unit, 19 coefficient memory, 81 prediction device, 91, 92 tap constructing unit, 93 classification unit, 94 coefficient memory, 95 tap constructing unit, 96 predictive computation unit, 101 downscaling unit, 102 prediction coefficient computing unit, 111 coefficient memory, 121 downscaling unit, 131 tap constructing unit, 132 prediction coefficient computing unit, 141 tap constructing unit, 142 predictive computation unit, 301 image generating device, 311 blur adding unit, 312, 313 noise adding unit, 314, 315 tap constructing unit, 316 classification unit, 317 tap constructing unit, 318 prediction coefficient computing unit, 319 coefficient memory

### BEST MODES FOR CARRYING OUT THE INVENTION

Hereinbelow, an embodiment of the present invention will be described with reference to the drawings.

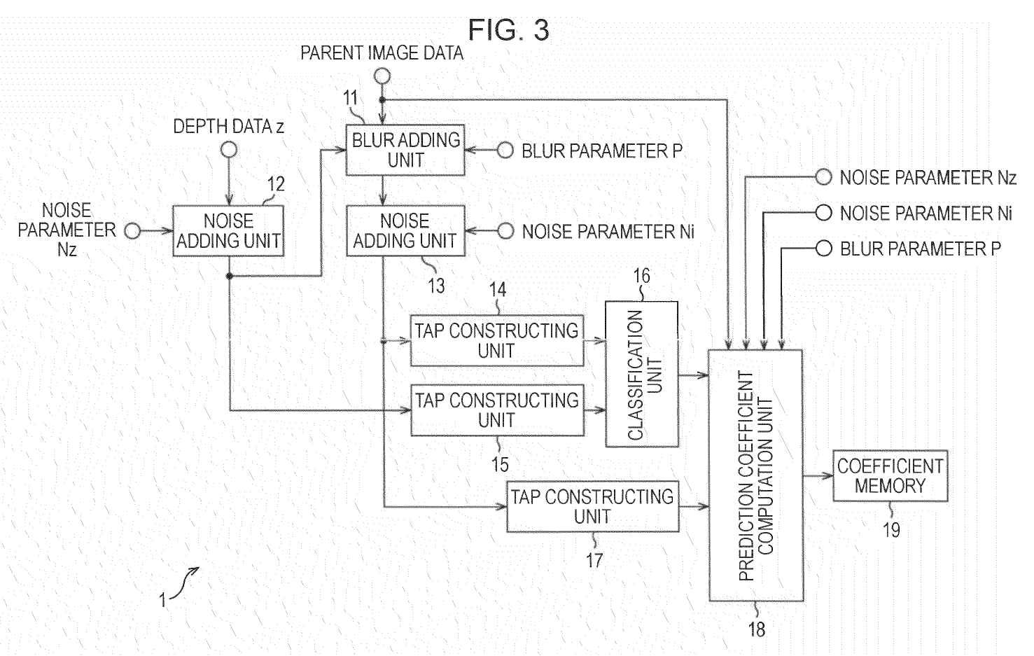

FIG. 3 is a block diagram showing the configuration of an embodiment of a learning device 1 to which the present invention is applied.

The learning device 1 as a prediction coefficient computing device in FIG. 3 is configured by a blur adding unit 11, a noise adding unit 12, a noise adding unit 13, a tap constructing unit 14, a tap constructing unit 15, a classification unit 16, a tap constructing unit 17, a prediction coefficient computing unit 18, and a coefficient memory 19, and learns prediction coefficients used when performing a prediction process of predicting, from a blurred image that is an image with blur, a blur-corrected image of the same size which is an image that is corrected for blurring, by a classification adaptive process.

Parent image data as the pixel value of each pixel of a parent image corresponding to a blur-corrected image that has undergone a prediction process is inputted to the blur adding unit 11 from an unillustrated device. The blur adding unit 11 acquires a blur parameter P specified by a user, and adds blur to the parent image data in accordance with a characteristic according to the blur parameter P, on the basis of depth data z that has undergone noise addition which is supplied from the noise adding unit 12.

Depth data z is three-dimensional positional data of a real-world object corresponding to an image, and is computed by stereo vision, laser measurement, or the like using a plurality of images captured by a plurality of cameras. For example, the depth data z is, when parent image data is acquired by an unillustrated camera, data on the pixel-by-pixel distance from the camera to a subject. The data on the pixel-by-pixel distance corresponding to each pixel can be obtained by, for example, a method disclosed in Japanese Unexamined Patent Application Publication No. 2005-70014.

The blur adding unit 11 supplies parent image data that has undergone blur addition to the noise adding unit 13 as student image data that is the pixel value of each pixel of a student image corresponding to a blurred image that has not undergone a prediction process.

The depth data z is inputted to the noise adding unit 12 from an unillustrated device. Also, the noise adding unit 12 acquires a noise parameter Nz, which is a parameter of noise added to depth data z specified by the user, and adds noise to the depth data z on the basis of a characteristic according to the noise parameter Nz. Then, the noise adding unit 12 supplies the depth data z that has undergone noise addition to the blur adding unit 11 and the tap constructing unit 15.

The noise adding unit 13 acquires a noise parameter Ni specified by the user, which is a parameter of noise added to student image data. The noise adding unit 13 adds noise to student image data supplied from the blur adding unit 11, on the basis of a characteristic according to the noise parameter Ni. Then, the noise adding unit 13 supplies the student image data that has undergone noise addition, to the tap constructing unit 14 and the tap constructing unit 17.

Incidentally, while provision of the noise adding unit 12 and the noise adding unit 13 makes it possible to obtain prediction coefficients that take removable of noise of a blurred image into consideration, these units can be omitted when no such consideration is made.

The tap constructing unit 14 sequentially sets a pixel that constitutes a parent image as a target pixel, and extracts several pixel values that constitute a student image, which are used for classifying the target pixel into a class, thereby constructing an image class tap from student image data. The tap constructing unit 14 supplies the image class tap to the classification unit 16.

The tap constructing unit 15 extracts the depth data z of several pixels, which is used for classifying a target pixel into a class, thereby constructing a depth class tap from the depth data z. The tap constructing unit 15 supplies the depth class tap to the classification unit 16.

The classification unit 16 classifies a target pixel into a class on the basis of the image class tap supplied from the tap constructing unit 14, and the depth class tap supplied from the tap constructing unit 15.

Classification is realized by setting, as classification codes, features computed from a plurality pieces of data that constitute a class tap.

Here, as a method of classification into classes, for example, ADRC (Adaptive Dynamic Range Coding) or the like can be adopted. Other than ADRC, various data compression processes and the like can be also used.

In a method using ADRC, pixel values that constitute an image class tap, and pieces of depth data z that constitute a depth class tap are each subjected to an ADRC process, and the class of a target pixel is determined in accordance with two ADRC codes obtained as a result.

Incidentally, in K-bit ADRC, for example, the largest value MAX and smallest value MIN of pixel values that constitute an image class tap are detected, DR=MAX−MIN is set as the local dynamic range of a collection of a plurality of pixel values as an image class tap, and each of the plurality of pixel values as an image class tap is re-quantized into K bits on the basis of this dynamic range DR. That is, the smallest value MIN is subtracted from individual pixel values as an image class tap, and the subtraction values are divided (quantized) by DR/2^{K}. Then, a bit string in which individual pixel values of K bits as an image class tap obtained in this way are arranged in a predetermined order is set as an ADRC code.

Therefore, in a case where an image class tap is subjected to, for example, a 1-bit ADRC process, after the smallest value MIN is subtracted, individual pixel values as the image class tap are divided by ½ of the difference between the largest value MAX and the smallest value MIN (the fractional portion is dropped), and thus the individual pixel values are converted into a 1-bit form (binarized). Then, a bit string in which the 1-bit pixel values are arranged in a predetermined order is set as an ADRC code. Also, similarly, with regard to a depth class tap, a bit string in which pieces of the depth data z of individual pixels of K bits as a depth class tap are arranged in a predetermined order is set as an ADRC code.

Incidentally, the method of performing classification on the basis of an image class tap may differ from the method of performing classification on the basis of a depth class tap. For example, the above-described ADRC may be adopted as the method of performing classification on the basis of an image class tap, and as the method of performing classification on the basis of a depth class tap, not only the above-described ADRC but also a method of performing classification into a class by smoothing the depth data z that constitutes the depth class tap, a method of performing classification into a class on the basis of the edges in pixels corresponding to the depth data z that constitutes the depth class tap, or the like may be adopted.

In the method of performing classification into a class by smoothing depth data z, a value obtained by adding up all the pieces of depth data z that constitute a depth class tap, dividing the result by the number of pixels corresponding to the pieces of depth data z that constitute the depth class tap, followed by multiplication by a predetermined constant is set as a class code, and a class is determined in accordance with the class code.

Also, in the method of performing classification into a class on the basis of the edges in pixels corresponding to depth data z, differences in depth data z between adjacent pixels are computed from depth data z that constitutes a depth class tap, and the positions of the edges are recognized on the basis of the differences. Then, a template indicating the positions of the edges is selected from among templates that are prepared in advance, the number of the template is set as a class code, and a class is determined in accordance with the class code.

The classification unit 16 supplies the class into which the target pixel is classified, to the prediction coefficient computing unit 18.

As described above, the classification unit 16 classifies the class of a target pixel on the basis of not only an image class tap but also a depth class tap, thereby making it possible to prevent a blurred image and a non-blurred image from being classified into the same class.

The tap constructing unit 17 extracts several pixel values that constitute a student image, which are used for predicting the pixel value of a target pixel, thereby constructing an image prediction tap from student image data. The tap constructing unit 17 supplies the image prediction tap to the prediction coefficient computing unit 18.

Incidentally, while it is possible to select an arbitrary pixel value as an image prediction tap, an image class tap, or a depth class tap, the pixel value of a target pixel and/or a predetermined pixel neighboring the target pixel can be selected.

The prediction coefficient computing unit 18 acquires a noise parameter Nz supplied to the noise adding unit 12, a noise parameter Ni supplied to the noise adding unit 13, and a blur parameter P supplied to the blur adding unit 11, which are specified by the user. On the basis of parent image data supplied from an unillustrated device and an image prediction tap supplied from the tap constructing unit 17, the prediction coefficient computing unit 18 computes prediction coefficients for each class supplied from the classification unit 16, and for each noise parameter Nz, noise parameter Ni, and blur parameter P, and supplies the prediction coefficients to the coefficient memory 19 to be stored therein.

Here, a description will be given of computation of prediction coefficients by the prediction coefficient computing unit 18.

For example, now, a case is considered in which as a prediction process, an image prediction tap is extracted from a blurred image, and by using the image prediction tap and prediction coefficients, the pixel values of a blur-corrected image are obtained (predicted) by a predetermined predictive computation.

Assuming that as a predetermined predictive computation, for example, a linear first-order predictive computation is adopted, the pixel value y of a pixel of a blur-corrected image (hereinafter, referred to as blur-corrected pixel as appropriate) is obtained by the following linear first-order equation.

$$\begin{matrix}[ Eq . 1 ] & \\ y = {\sum }_{n = 1}^{N} {w}_{n} {x}_{n} & ( 1 )\end{matrix}$$

It should be noted that in Equation (1), xₙ represents the pixel value of the n-th pixel of a blurred image (hereinafter, referred to as blurred pixel as appropriate) that constitutes an image prediction tap with respect to the blur-corrected pixel y, and wₙ represents the n-th prediction coefficient that is multiplied by the pixel value of the n-th blurred pixel. Incidentally, in Equation (1), it is assumed that the image prediction tap is constituted by pixel values x₁, x₂, . . . , , x_{N} of a plurality of N blurred pixels. In this case, N prediction coefficients exist per one class.

It is also possible to obtain the pixel value y of a blur-corrected pixel not by the linear first-order equation indicated by Equation (1) but by a second or higher order equation. That is, as an estimation equation, an arbitrary function can be used, irrespective of whether it be a linear function or a non-linear function.

Now, let the true value of the pixel value of a blur-corrected pixel of the k-th sample be represented by yₖ, and a predicted value of the true value yₖ obtained by Equation (1) be yₖ′, a prediction error eₖ therebetween is represented by the following equation.

[Eq. 2]

eₖ=yₖ−yₖ′ (2)

Now, since the predicted value yₖ′ in Equation (2) is obtained in accordance with Equation (1), replacing yₖ′ in Equation (2) in accordance with Equation (1) gives the following equation.

$$\begin{matrix}[ Eq . 3 ] & \\ {e}_{k} = {y}_{k} - ( {\sum }_{n = 1}^{N} {w}_{n } {x}_{n , k} ) & ( 3 )\end{matrix}$$

It should be noted that in Equation (3), x_{n,k} represents the pixel value of the n-th blurred pixel that constitutes an image prediction tap with respect to the blur-corrected pixel of the k-th sample.

While a tap coefficient wₙ that makes the prediction error eₖ in Equation (3) (or Equation (2)) become zero is optimal for predicting the pixel value of a blur-corrected pixel, it is generally difficult to obtain such a prediction coefficient wₙ with respect to every blur-corrected pixel.

Accordingly, supposing that, for example, the least square method is adopted as a criterion indicating that a prediction coefficient wₙ is optimal, the optimal prediction coefficient wₙ can be obtained by minimizing the total sum E of square errors represented by the following equation.

$$\begin{matrix}[ Eq . 4 ] & \\ E = {\sum }_{k = 1}^{K} {e}_{k}^{2} & ( 4 )\end{matrix}$$

It should be noted that in Equation (4), K represents the number of samples (the number of samples for learning) of sets including the pixel value yₖ of a blur-corrected pixel, and the pixel values x_{1,k}, x_{2,k}, . . . , x_{N,k} of blurred pixels that constitute an image prediction tap with respect to the blur-corrected pixel. That is, K represents the number of samples of sets including the pixel values of pixels of a parent image, and the pixel values of pixels of a student image.

As indicated by Equation (5), the smallest value (minimum value) of the total sum E of square errors in Equation (4) is given by wₙ that makes the result of partial differentiation of the total sum E with respect to the prediction coefficient wₙ become zero.

$$\begin{matrix}[ Eq . 5 ] & \\ \frac{\partial E}{\partial {w}_{n}} = {e}_{1} \frac{\partial {e}_{1}}{\partial {w}_{n}} + {e}_{2} \frac{\partial {e}_{2}}{\partial {w}_{n}} + … + {e}_{k} \frac{\partial {e}_{k}}{\partial {w}_{n}} = 0 \\ ( n = 1 , 2 , … , N ) & ( 5 )\end{matrix}$$

On the other hand, by performing partial differentiation of Equation (3) with respect to the prediction coefficient wₙ, the following equation is obtained.

$$\begin{matrix}[ Eq . 6 ] & \\ \frac{\partial {e}_{k}}{\partial {w}_{1}} = - {x}_{1 , k} , \frac{\partial {e}_{k}}{\partial {w}_{2}} = - {x}_{2 , k} , … , \frac{\partial {e}_{k}}{\partial {w}_{N}} = - {x}_{N , k} , \\ ( k = 1 , 2 , … , K ) & ( 6 )\end{matrix}$$

The following equation is obtained from Equation (5) and Equation (6).

$$\begin{matrix}[ Eq . 7 ] & \\ {\sum }_{k = 1}^{K} {e}_{k} {x}_{1 , k} = 0 , {\sum }_{k = 1}^{K} {e}_{k} {x}_{2 , k} = 0 , … {\sum }_{k = 1}^{K} {e}_{k} {x}_{N , k} = 0 & ( 7 )\end{matrix}$$

By substituting Equation (3) into eₖ in Equation (7), Equation (7) can be represented by a normal equation indicated in Equation (8).

$$\begin{matrix}[ Eq . 8 ] & \\ [ \begin{matrix}( {\sum }_{k = 1}^{K} {x}_{1 , k} {x}_{1 , k} ) & ( {\sum }_{k = 1}^{K} {x}_{1 , k} {x}_{2 , k} ) & … & ( {\sum }_{k = 1}^{K} {x}_{1 , k} {x}_{n , k} ) \\ ( {\sum }_{k = 1}^{K} {x}_{2 , k} {x}_{1 , k} ) & ( {\sum }_{k = 1}^{K} {x}_{2 , k} {x}_{2 , k} ) & … & ( {\sum }_{k = 1}^{K} {x}_{2 , k} {x}_{n , k} ) \\ ⋮ & ⋮ & ⋱ & ⋮ \\ ( {\sum }_{k = 1}^{K} {x}_{n , k} {x}_{1 , k} ) & ( {\sum }_{k = 1}^{K} {x}_{n , k} {x}_{2 , k} ) & … & ( {\sum }_{k = 1}^{K} {x}_{n , k} {x}_{n , k} )\end{matrix} ] [ \begin{matrix}{w}_{1} \\ {w}_{2} \\ ⋮ \\ {w}_{n}\end{matrix} ] = [ \begin{matrix}( {\sum }_{k = 1}^{K} {x}_{1 , k} {y}_{k} ) \\ ( {\sum }_{k = 1}^{K} {x}_{2 , k} {y}_{k} ) \\ ⋮ \\ ( {\sum }_{k = 1}^{K} {x}_{n , k} {y}_{k} )\end{matrix} ] & ( 8 )\end{matrix}$$

The normal equation of Equation (8) can be solved with respect to the prediction coefficient wₙ by using, for example, the sweep out method (Gauss-Jordan elimination method).

By setting up and solving the normal equation of Equation (8) for each class, noise parameter Nz, noise parameter Ni, and blur parameter P, the prediction coefficient computing unit 18 can obtain an optimal prediction coefficient (in this case, a prediction coefficient that minimizes the total sum E of square errors) wₙ for each class, noise parameter Nz, noise parameter Ni, and blur parameter P.

Also, according to the prediction process, by performing the computation of Equation (1) using the prediction coefficient wₙ for each class, noise parameter Nz, noise parameter Ni, and blur parameter P obtained as described above, a blurred image is transformed into a blur-corrected image.

The coefficient memory 19 stores the prediction coefficient wₙ supplied from the prediction coefficient computing unit 18.

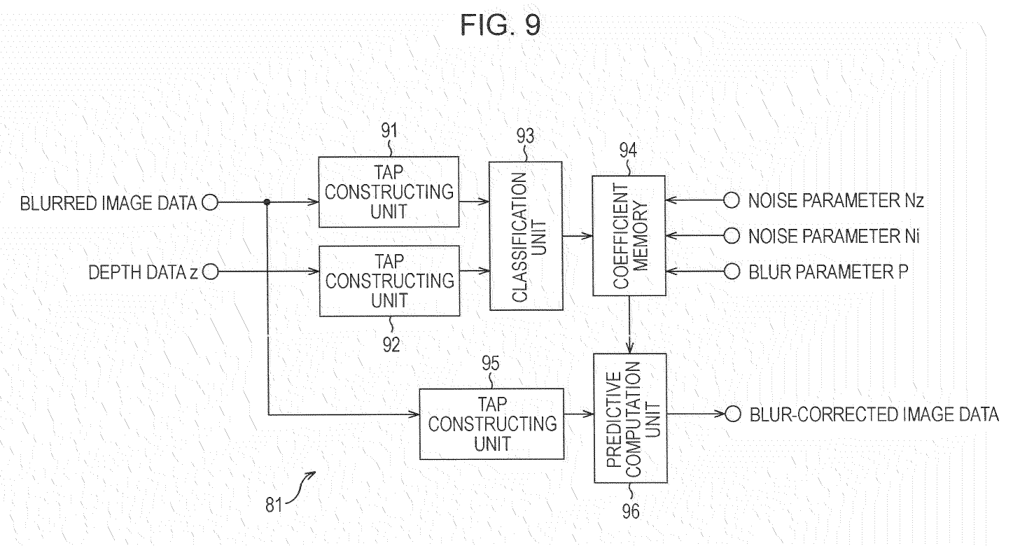

As described above, in the learning device 1 in FIG. 3, it is possible to prevent a blurred image and a non-blurred image from being classified into the same class. Thus, in a prediction device 81 described later with reference to FIG. 9, by performing a prediction process using the prediction coefficient wₙ learned for each classified class, blur of a blurred image can be accurately corrected, and the blurred image can be transformed into a high-quality blur-corrected image.

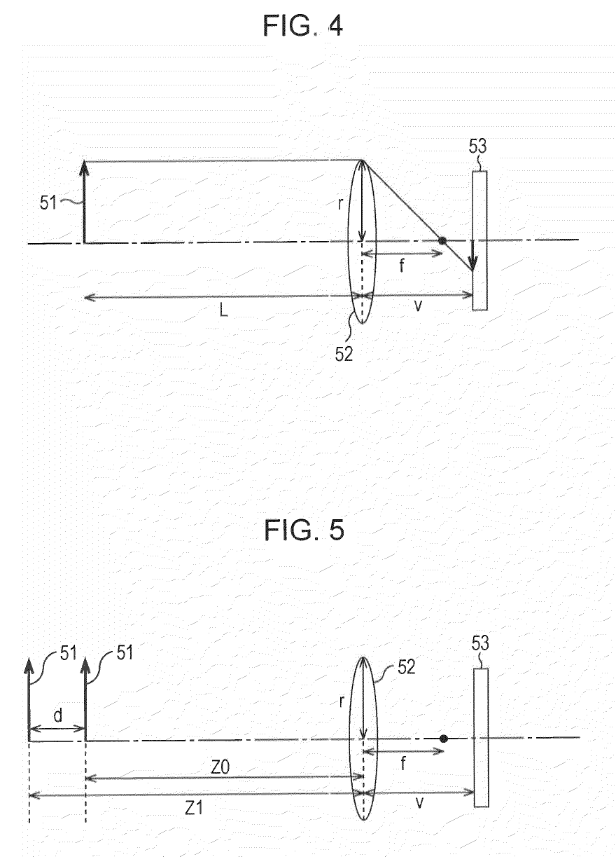

Next, referring to FIG. 4 through FIG. 6, a description will be given of the addition of blur to parent image data by the blur adding unit 11 in FIG. 3.

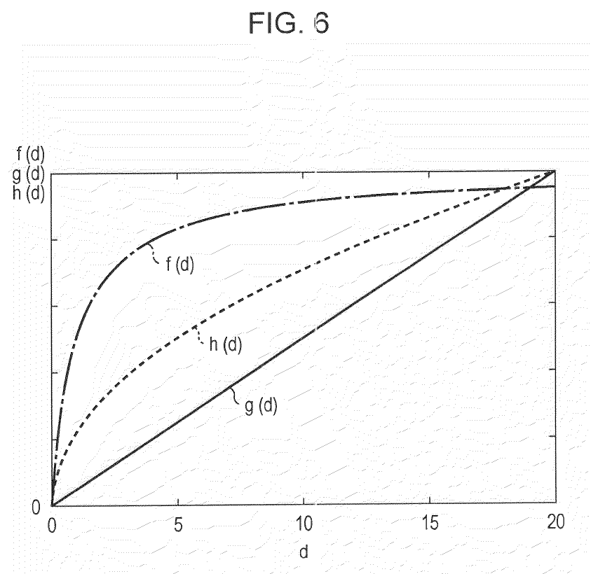

First, referring to FIG. 4 and FIG. 5, a description will be given of an equation for obtaining the size a of spread of blur, as a characteristic of addition of blur.

As shown in FIG. 4, in a case when light from an object 51 is made incident on a sensor 53 via a lens 52, the lens combination formula is represented by the following Equation (9).

1/f=1/v+1/L (9)

Incidentally, in Equation (9), f represents the focal length of the lens 52, v represents the distance between the lens 52 and the sensor 53, and L represents the distance between the object 51 and the lens 52.

Also, it is known that if a two-dimensional Gaussian function with unit volume is used as a blur model for an image which is formulated by taking the structure or mode of an image capturing system that captures an object into consideration, and which is a model that adds blur to an object image without blur, the size a of spread of blur is represented by Equation (10) below.

σ=rv(1/f−1/v−1/L) (10)

As shown in FIG. 5, letting the distance L when no blurring occurs, that is, when in focus, be depth data z0, and letting the distance L when blurring occurs, that is, when not in focus be depth data z1, the difference between a size σ1 when blurring occurs, and a size σ0 when no blurring occurs is represented by Equation (11) below.

σ1−σ0=(fv/F)×(z1−z0)/(z1×z0) (11)

Incidentally, in Equation (11), F represents an F number, that is, f/r.

In Equation (11), letting the size σ0 when no blurring occurs be zero, a size σ_{d} when the object 51 is located at a position where the object 51 is spaced from the focusing position by a distance d is represented by Equation (12) below.

σ_{d}=(fv/F)×(z1−z0)/(z1×z0) (12)

Here, when fv/F is given as k, Equation (12) is represented by Equation (13) below.

σ_{d}=k×(z1−z0)/(z1×z0) (13)

Further, when d=z1−z0 is given, Equation (13) is represented by Equation (14) below.

σ_{d}=(k/z0)×d/(d+z0) (14)

According to Equation (14), the size ad is a function of the distance d, and if the function is given as f(d), the function f(d) is a function representing a characteristic of addition of blur, and is represented by Equation (15) below.

f(d)=(k/z0)×d/(d+z0) (15)

According to Equation (15), the function f(d) converges to a constant k/z0 as the distance d becomes larger.

Incidentally, as a function representing a characteristic of addition of blur, not only the function f(d) but also a function g(d) that is a linear approximation of the size σ, or a function h(d) that is a square-root approximation of the size σ can also be used. The function g(d) and the function h(d) are represented by Equation (16) and Equation (17) below.

[Eq. 9]

g(d)=ad (16)

h(d)=\sqrt{bd} (17)

Incidentally, a in Equation (16), and b in Equation (17) each represent a preset constant.

FIG. 6 is a graph showing the function f(d), the function g(d), and the function h(d). As shown in FIG. 6, the function f(d) converges to a given value as the distance d becomes larger. Also, the function g(d) is represented by a straight line, and the function h(d) is represented by a curve indicating a square root.

Incidentally, in FIG. 6, in the function f(d), k is 1.0, and in the function g(d), a is 0.05. Also, in the function h(d), b is 0.05.

The blur adding unit 11 selects one from among the function f(d), the function g(d), and the function h(d), in accordance with the blur parameter P specified by the user, which is a parameter for selecting a function representing a characteristic of addition of blur, adds blur to parent image data on the basis of the characteristic represented by the selected function, and generates student image data.

Specifically, the blur adding unit 11 generates student image data for each pixel in accordance with Equation (18) below.

[Eq. 10]

Y(x,y)=Σ{WT(k,l)×X(x+k,y+l)} (18)

Incidentally, in Equation (18), Y(x, y) represents the pixel value of a pixel at a position whose x-coordinate is x and whose y-coordinate is y, among pixels that constitute a student image. X(x+k, y+l) represents the pixel value of a pixel at a position whose x-coordinate is x+k and whose y-coordinate is y+l (position spaced by coordinates (k, l) from the position (x, y) of a target pixel), among pixels that constitute a parent image. Also, in Equation (18), WT(k, l) is a point spread function (Gaussian PSF (Point Spread Function)) of blur, and is represented by Equation (19) below.

$$\begin{matrix}[ Eq . 11 ] & \\ WT ( k , 1 ) = \frac{1}{2 π {S}^{2} ( x + k , y + 1 )} {e}^{- \frac{( {k}^{2} + {1}^{2} )}{2 {S}^{2} ( x + k , y + 1 )}} & ( 19 )\end{matrix}$$

Incidentally, in Equation (19), S(x+k, y+l) represents a function selected from among the function f(d), the function g(d), and the function h(d), in a case where the distance d is a value obtained by subtracting depth data z0 from depth data z of a pixel at a position whose x-coordinate is x+k and whose y-coordinate is y+1.

According to Equation (18) and Equation (19), the pixel value of a target pixel that has undergone blur addition is obtained by adding up the pixel value spread from a pixel at a position whose x-coordinate is x+k and whose y coordinate is y+l, to a target pixel at a position whose x-coordinate is x and whose y coordinate is y.

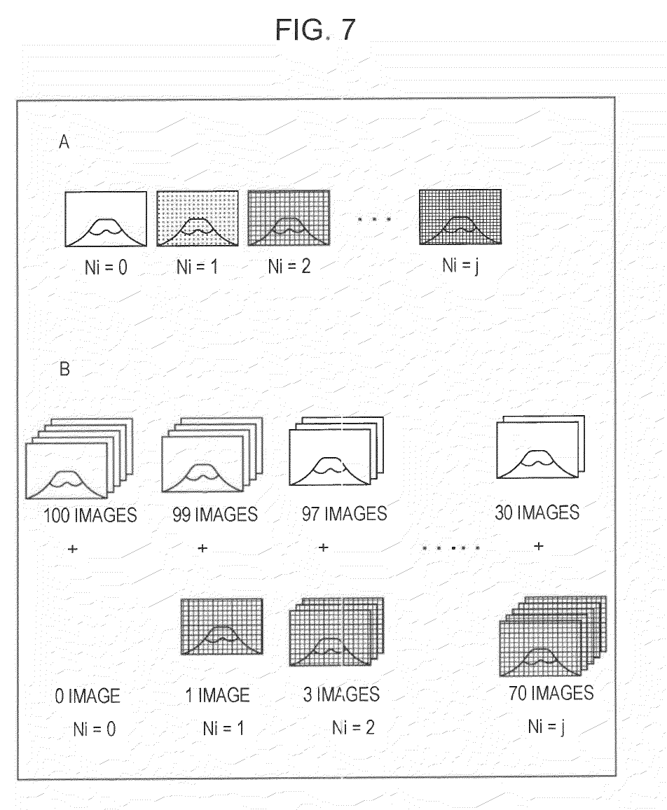

Next, referring to A of FIG. 7 and B of FIG. 7, a description will be given of a method of adding noise by the noise adding unit 13 in FIG. 3.

As methods of adding noise, there are, for example, a first method of adding noise whose amplitude level is varied in a stepwise manner in accordance with a noise parameter Ni, a second method of generating images with noise added and images with no noise added at a ratio according to the noise parameter Ni, and the like.

First, the first method will be described with reference to A of FIG. 7.

Incidentally, in A of FIG. 7, it is assumed that the noise parameter Ni is a value from zero to j. This applies similarly to B of FIG. 7 described later. Incidentally, the noise parameter Ni in this case is a parameter that specifies the amplitude level of noise.

As shown in A of FIG. 7, the first method adds noise whose amplitude level is varied in a stepwise manner such that the amplitude level of noise added to a student image becomes larger as the value of the noise parameter Ni becomes larger. That is, as shown in A of FIG. 7, in the first method, in a case when the value of the noise parameter Ni is zero, noise is not added to the student image. As the value of the noise parameter Ni becomes larger, the amplitude level of noise added to the student image becomes larger, and in a case when the value of the noise parameter Ni is j, noise with the largest amplitude level is added to the student image.

In this case, as indicated by, for example, Equation (23) described later, by defining noise by an expression RΣmseq[m] represented by the product of a coefficient R, and a function mseq[m] that generates a pseudo-random number, and controlling the coefficient R in accordance with the value of the noise parameter Ni, a control can be performed such that the amplitude level of noise becomes larger in accordance with the value of the noise parameter Ni.

Next, the second method will be described with reference to B of FIG. 7.

Incidentally, in the example in B of FIG. 7, it is assumed that 100 student images that have undergone noise addition are generated with respect to one student image.

As shown in B of FIG. 7, in the second method, a total of 100 images including student images to which noise is not added, and student images to which noise of a predetermined amplitude level has been added, are generated at a ratio according to the noise parameter Ni, as student images that have undergone noise addition. That is, as shown in B of FIG. 7, in a case when the value of the noise parameter Ni is zero, 100 student images to which noise is not added are generated as 100 student images that have undergone noise addition. In a case when the value of the noise parameter Ni is 1, 99 student images to which noise is not added, and one student image to which noise has been added are generated as 100 student images that have undergone noise addition. Incidentally, the noise parameter Ni in this case is a parameter that specifies the mixing ratio of noise.

Subsequently, likewise, as the value of the noise parameter Ni becomes larger, the number of student images to which noise is not added, which constitute the 100 student images obtained after noise addition, decreases, and the number of student images to which noise has been added increases, and in a case when the value of the noise parameter Ni is j, 30 student images to which noise is not added, and 70 student images to which noise has been added, are generated as 100 student images that have undergone noise addition.

In this case, the prediction coefficient computing unit 18 in FIG. 3 performs computation of prediction coefficients in accordance with Equation (8), by using one parent image and 100 student images as one sample. That is, the prediction coefficient computing unit 18 sets up and solves a normal equation of Equation (20) below for each class, noise parameter Nz, noise parameter Ni, and blur parameter P, thereby obtaining an optimal prediction coefficient wₙ for each class, noise parameter Nz, noise parameter Ni, and blur parameter P.

$$\begin{matrix}[ Eq . 12 ] & \\ [ \begin{matrix}( \begin{matrix}{\sum }_{k = 1}^{K} \\ ( {\sum }_{q = 1}^{Q} {x}_{1 , qk} {x}_{1 , qk} )\end{matrix} ) & ( \begin{matrix}{\sum }_{k = 1}^{K} \\ ( {\sum }_{q = 1}^{Q} {x}_{1 , qk} {x}_{2 , qk} )\end{matrix} ) & … & ( \begin{matrix}{\sum }_{k = 1}^{K} \\ ( {\sum }_{q = 1}^{Q} {x}_{1 , qk} {x}_{n , qk} )\end{matrix} ) \\ ( \begin{matrix}{\sum }_{k = 1}^{K} \\ ( {\sum }_{q = 1}^{Q} {x}_{2 , qk} {x}_{1 , qk} )\end{matrix} ) & ( \begin{matrix}{\sum }_{k = 1}^{K} \\ ( {\sum }_{q = 1}^{Q} {x}_{2 , qk} {x}_{2 , qk} )\end{matrix} ) & … & ( \begin{matrix}{\sum }_{k = 1}^{K} \\ ( {\sum }_{q = 1}^{Q} {x}_{2 , qk} {x}_{n , qk} )\end{matrix} ) \\ ⋮ & ⋮ & ⋱ & ⋮ \\ ( \begin{matrix}{\sum }_{k = 1}^{K} \\ ( {\sum }_{q = 1}^{Q} {x}_{n , qk} {x}_{1 , qk} )\end{matrix} ) & ( \begin{matrix}{\sum }_{k = 1}^{K} \\ ( {\sum }_{q = 1}^{Q} {x}_{n , qk} {x}_{2 , qk} )\end{matrix} ) & … & ( \begin{matrix}{\sum }_{k = 1}^{K} \\ ( {\sum }_{q = 1}^{Q} {x}_{n , qk} {x}_{n , qk} )\end{matrix} )\end{matrix} ] [ \begin{matrix}{w}_{1} \\ {w}_{2} \\ ⋮ \\ {w}_{n}\end{matrix} ] = [ \begin{matrix}( {\sum }_{k = 1}^{K} ( {\sum }_{q = 1}^{Q} {x}_{1 , qk} {y}_{k} ) ) \\ ( {\sum }_{k = 1}^{K} ( {\sum }_{q = 1}^{Q} {x}_{2 , qk} {y}_{k} ) ) \\ ⋮ \\ ( {\sum }_{k = 1}^{K} ( {\sum }_{q = 1}^{Q} {x}_{n , qk} {y}_{k} ) )\end{matrix} ] & ( 20 )\end{matrix}$$

Incidentally, in Equation (20), x_{n,qk}, represents the pixel value of the n-th pixel of the q-th student image which constitutes an image prediction tap for the pixel of a blur-corrected image of the k-th sample. Also, Q represents the number of student images with respect to one sample, which is 100 in the example in B of FIG. 7.

The nose adding unit 13 adds noise to a student image by the first method or second method described above. Incidentally, although not described, addition of noise in the noise adding unit 12 is also performed similarly. In this case, for example, random noise attributable to an image capturing device, or random noise due to an influence of extraneous light, a difference in reflectance between object surfaces, a measurement error, or the like is added to depth data z.

Incidentally, the method of adding noise described in each of A of FIG. 7 and B of FIG. 7 is one example, and the method may be another method. For example, the noise adding unit 12 may add confusion noise caused by smoothing or the like due to an influence of confusion due to reflection or measurement precision, to depth data z by using a function similar to the function representing a characteristic of addition of blur.

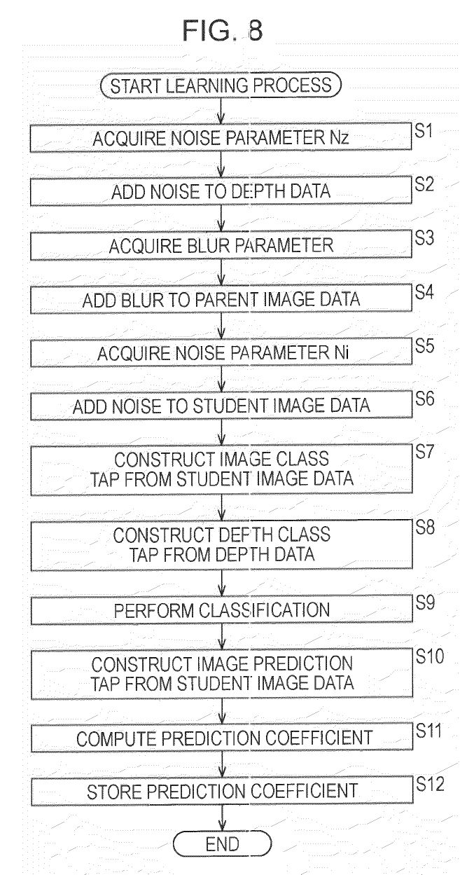

Next, referring to FIG. 8, a description will be given of a learning process in which the learning device 1 in FIG. 3 learns a prediction coefficient wₙ. This learning process is started when, for example, parent image data and depth data z are inputted to the learning device 1 in FIG. 3.

In step S1, the noise adding unit 12 acquires a noise parameter Nz specified by the user. In step S2, the noise adding unit 12 adds noise to depth data z by a method such as the first method or the second method described above with reference to FIG. 7, on the basis of a characteristic according to the noise parameter Nz.

In step S3, the blur adding unit 11 acquires a blur parameter P specified by the user. In step S4, on the basis of depth data z obtained after noise addition which is supplied from the noise adding unit 12, the blur adding unit 11 adds blur to parent image data inputted from an unillustrated device, on the basis of a characteristic according to the blur parameter P.

Specifically, the blur adding unit 11 selects the function f(d), the function g(d), or the function h(d) in accordance with the blur parameter P. Next, in accordance with Equation (18) and Equation (19) in which the selected function is applied to S, the blur adding unit 11 obtains the pixel value Y(x, y) of a target pixel, that is, the pixel value of a pixel that constitutes a student image on the basis of the depth data z. Then, the blur adding unit 11 supplies the pixel value of each pixel that constitutes the student image to the noise adding unit 13 as student image data.

In step S5, the noise adding unit 13 acquires a noise parameter Ni specified by the user. In step S6, the noise adding unit 13 adds noise to student image data supplied from the blur adding unit 11, by a method such as the first method or second method described above with reference to FIG. 7, on the basis of a characteristic according to the noise parameter Ni, and supplies student image data obtained after noise addition, to the tap constructing unit 14 and the tap constructing unit 17.

In step S7, the tap constructing unit 14 constructs an image class tap by extracting predetermined pieces of student image data, and supplies the image class tap to the classification unit 16. In step S8, the tap constructing unit 15 constructs a depth class tap by extracting predetermined pieces of depth data z, and supplies the depth class tap to the classification unit 16.

In step S9, the classification unit 16 classifies a target pixel into a class, on the basis of the image class tap supplied from the tap constructing unit 14, and the depth class tap supplied from the tap constructing unit 15. In step S10, the tap constructing unit 17 constructs an image prediction tap by extracting predetermined pieces of student image data, and supplies the image prediction tap to the prediction coefficient computing unit 18.

In step S11, on the basis of parent image data supplied from an unillustrated device, and the image prediction tap supplied from the tap constructing unit 17, the prediction coefficient computing unit 18 computes a prediction coefficient wₙ for each class supplied from the classification unit 16, and for each noise parameter Nz, noise parameter Ni, and blur parameter P in accordance with Equation (8) or Equation (20) described above, and supplies the prediction coefficient wₙ to the coefficient memory 19.

In step S12, the coefficient memory 19 stores the prediction coefficient wₙ supplied from the prediction coefficient computing unit 18, and the processing ends.

FIG. 9 is a block diagram showing the configuration of the prediction device 81 as a prediction coefficient computing device that performs a prediction process using the prediction coefficient wₙ learned in the learning device 1 in FIG. 3.

The prediction device 81 in FIG. 9 is configured by a tap constructing unit 91, a tap constructing unit 92, a classification unit 93, a coefficient memory 94, a tap constructing unit 95, and a predictive computation unit 96.

Blurred image data as the pixel value of each pixel that constitutes a blurred image, and depth data z corresponding to the blurred image data are inputted to the prediction device 81 in FIG. 9 from an unillustrated device. This blurred image data is supplied to the tap constructing unit 91 and the tap constructing unit 95, and the depth data z is supplied to the tap constructing unit 92.

Like the tap constructing unit 14 in FIG. 3, the tap constructing unit 91 sequentially sets a pixel that constitutes a blur-corrected image as a target pixel, and extracts several pixel values that constitute a blurred image, which are used for classifying the target pixel into a class, thereby constructing an image class tap from blurred image data. The tap constructing unit 91 supplies the image class tap to the classification unit 93.

Like the tap constructing unit 15, the tap constructing unit 92 extracts several pieces of depth data z used for classifying a target pixel into a class, thereby constructing a depth class tap from the depth data z. The tap constructing unit 92 supplies the depth class tap to the classification unit 93.

Like the classification unit 16, the classification unit 93 classifies a target pixel into a class on the basis of the image class tap supplied from the tap constructing unit 91, and the depth class tap supplied from the tap constructing unit 92, and supplies the class to the coefficient memory 94.

In the coefficient memory 94, the prediction coefficient wₙ for each class, noise parameter Nz, noise parameter Ni, and blur parameter P stored in the coefficient memory 19 in FIG. 3 is stored. The coefficient memory 94 acquires a noise parameter Nz, a noise parameter Ni, and a blur parameter P that are specified by the user.

On the basis of the class supplied from the classification unit 93, and the noise parameter N, the noise parameter Ni, and the blur parameter P that are specified by the user, the coefficient memory 94 reads a prediction coefficient wₙ corresponding to the class, the noise parameter Nz, the noise parameter Ni, and the blur parameter P from among prediction coefficients wₙ that have been already stored, and provides the prediction coefficient wₙ to the predictive computation unit 96.

Like the tap construction unit 17, the tap constructing unit 95 extracts several pixel values that constitute a blurred image, which are used for predicting the pixel value of a target pixel, thereby constructing an image prediction tap from blurred image data. The tap constructing unit 95 supplies the image prediction tap to the predictive computation unit 96.

The predictive computation unit 96 performs a predictive computation for obtaining a predicted value of the pixel value of a target pixel, by using the image prediction tap supplied from the tap constructing unit 95, and the prediction coefficient wₙ provided from the coefficient memory 94. Specifically, the predictive computation unit 96 performs a predictive computation that is a computation of a linear first-order equation of Equation (1) described above. Accordingly, the predictive computation unit 96 obtains a predicted value of the pixel value of a target pixel, that is, the pixel value of a pixel that constitutes a blur-corrected image. Then, the predictive computation unit 96 outputs the pixel value of each pixel that constitutes a blur-corrected image as blur-corrected image data.

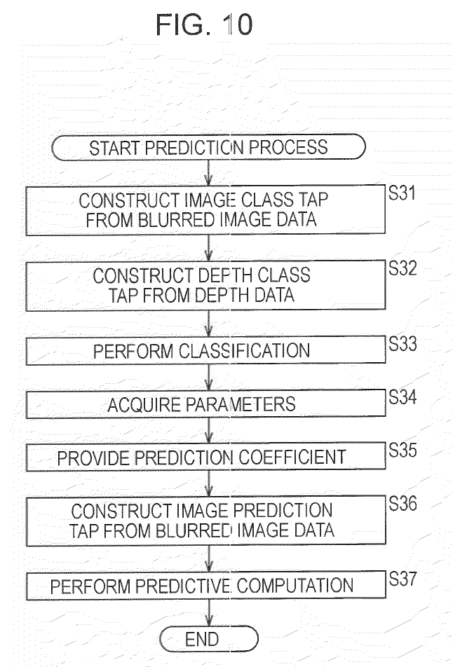

Next, referring to FIG. 10, a description will be given of a prediction process in which the prediction device 81 in FIG. 9 predicts blur-corrected image data. This prediction process is started when, for example, blurred image data and depth data z are inputted to the prediction device 81.

In step S31, the tap constructing unit 91 constructs an image class tap from the blurred image data, and supplies the image class tap to the classification unit 93. In step S32, the tap constructing unit 92 constructs a depth class tap from the depth data z, and supplies the depth class tap to the classification unit 93.

In step S33, the classification unit 93 classifies a target pixel into a class, on the basis of the image class tap supplied from the tap constructing unit 91, and the depth class tap supplied from the tap constructing unit 92, and supplies the class to the coefficient memory 94. In step S34, the coefficient memory 94 acquires a noise parameter Nz, a noise parameter Ni, and a blur parameter P that are specified by the user.

In step S35, on the basis of the class supplied from the classification unit 93, and the noise parameter N, the noise parameter Ni, and the blur parameter P that are specified by the user, the coefficient memory 94 reads a prediction coefficient wₙ corresponding to the class, the noise parameter Nz, the noise parameter Ni, and the blur parameter P from among prediction coefficients wₙ that have been already stored, and provides the prediction coefficient wₙ to the predictive computation unit 96.

In step S36, the tap constructing unit 95 constructs an image prediction tap from the blurred image data, and supplies the image prediction tap to the predictive computation unit 96.

In step S37, the predictive computation unit 96 performs a predictive computation that is a computation of a linear first-order equation of Equation (1) described above, by using the image prediction tap supplied from the tap constructing unit 95, and the prediction coefficient wₙ provided from the coefficient memory 94, obtains the pixel value of each pixel that constitutes a blur-corrected image, and outputs the pixel value as blurred-corrected image data. Then, the processing ends.

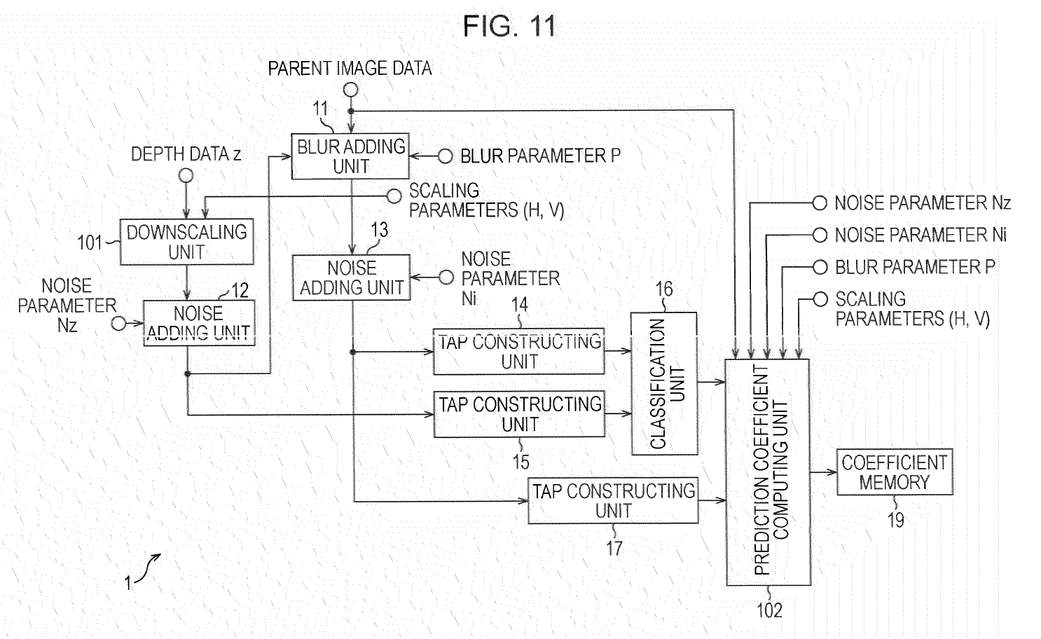

FIG. 11 is a block diagram showing the configuration of another embodiment of the learning device 1.

The learning device 1 in FIG. 11 is configured by the blur adding unit 11, the noise adding unit 12, the noise adding unit 13, the tap constructing unit 14, the tap constructing unit 15, the classification unit 16, the tap constructing unit 17, the coefficient memory 19, a downscaling unit 101, and a prediction coefficient computing unit 102. Even in a case where the size of a parent image corresponding to depth data z inputted from an unillustrated device is large in comparison to the size of a parent image corresponding to parent image data inputted together with it, by using a blurred image of the same size as the parent image corresponding to the inputted parent image data, and corresponding depth data z, the prediction coefficient wₙ used when performing a prediction process of predicting, from a blurred image, a blur-corrected image of the same size as the blurred image is learned.

Incidentally, in FIG. 11, components that are the same as those of the learning device 1 in FIG. 3 are denoted by the same reference numerals.

That is, in the learning device 1 in FIG. 11, the downscaling unit 101 is further provided to the learning device 1 in FIG. 3, and the prediction coefficient computing unit 102 is provided instead of the prediction coefficient computing unit 18.

Depth data z is inputted to the downscaling unit 101 from an unillustrated device. The downscaling unit 101 acquires scaling parameters (H, V) specified by the user, which are constituted by a horizontal scaling parameter H that represents the size in the horizontal direction of a parent image corresponding to depth data z that has undergone downscaling, and a vertical scaling parameter V that represents the size in the vertical direction.

The downscaling unit 101 performs downscaling of the depth data z on the basis of the scaling parameters (H, V) so that, for example, the size of a parent image corresponding to depth data z becomes the same as the size of a parent image corresponding to parent image data inputted to the blur adding unit 11, and supplies the downscaled depth data z to the noise adding unit 12.

The prediction coefficient computing unit 102 acquires a noise parameter Nz, a noise parameter Ni, a blur parameter P, and scaling parameters (H, V) that are specified by the user. On the basis of parent image data supplied from an unillustrated device, and an image prediction tap supplied from the tap constructing unit 17, the prediction coefficient computing unit 102 computes a prediction coefficient Wₙ for each class classified on the basis of an image class tap, and a depth class tap constructed from depth data z that has undergone downscaling, and for each noise parameter Nz, noise parameter Ni, blur parameter P, and scaling parameters (H, V), and supplies the prediction coefficient Wₙ to the coefficient memory 19.

As described above, the learning device 1 in FIG. 11 performs downscaling of inputted depth data z. Thus, even in a case where the size of a parent image corresponding to depth data z inputted to the downscaling unit 101 is large in comparison to the size of a parent image corresponding to parent image data inputted to the blur adding unit 11 together with it, by using the depth data z that has undergone downscaling, the learning device 1 can learn a prediction coefficient wₙ used for performing a prediction process using a blurred image of the same size as the parent image corresponding to the parent image data inputted to the blur adding unit 11, and corresponding depth data z.

That is, for example, the learning device 1 in FIG. 11 can learn a prediction coefficient wₙ used for a prediction process of predicting a blur-corrected image from a blurred image of a standard size, by using, as a parent image, a reduced image of a captured image having a size larger than standard.

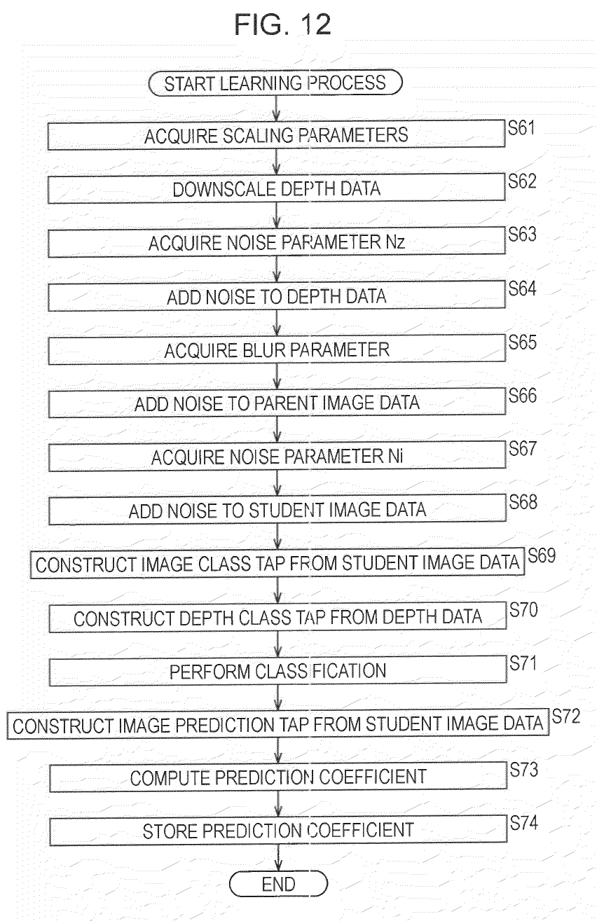

Next, referring to FIG. 12, a description will be given of a learning process in which the learning device 1 in FIG. 11 learns a prediction coefficient wₙ. This learning process is started when, for example, parent image data and depth data z are inputted to the learning device in FIG. 11.

In step S61, the downscaling unit 101 acquires scaling parameters (H, V). In step S62, the downscaling unit 101 downscales the depth data z on the basis of the scaling parameters (H, V) so as to match the size of a parent image corresponding to the parent image data inputted to the blur adding unit 11, and supplies the downscaled depth data z to the noise adding unit 12.

Since the processes from step S63 through step S72 are similar to the processes from step S1 to step S10 in FIG. 8, description thereof is omitted.

In step S73, on the basis of parent image data supplied from an unillustrated device, and an image prediction tap supplied from the tap constructing unit 17, the prediction coefficient computing unit 102 computes a prediction coefficient Wₙ for each class supplied from the classification unit 16, and for each noise parameter Nz, noise parameter Ni, blur parameter P, and scaling parameters (H, V), and supplies the prediction coefficient Wₙ to the coefficient memory 19.

In step S74, as in step S12, the coefficient memory 19 stores the prediction coefficient wₙ supplied from the prediction coefficient computing unit 102, and the processing ends.

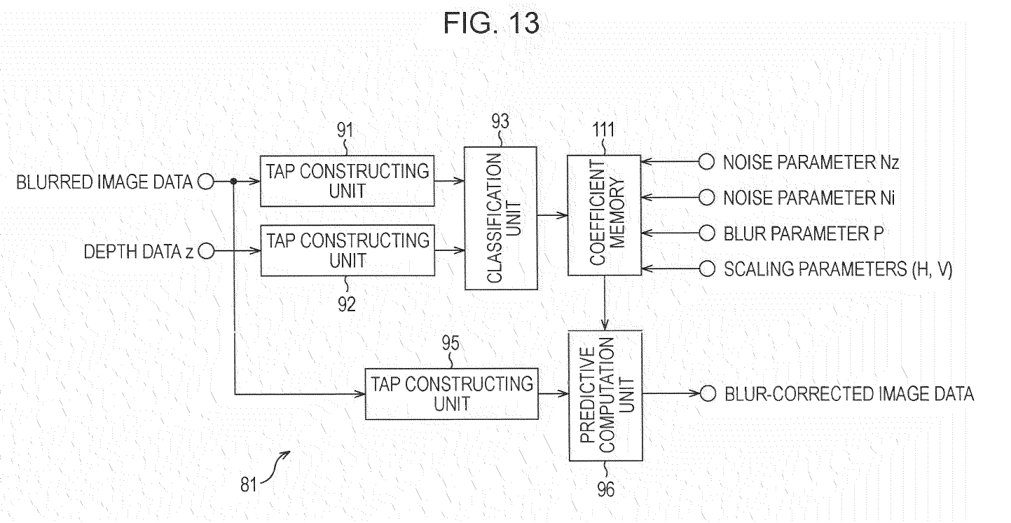

FIG. 13 is a block diagram showing the configuration of the prediction device 81 that performs a prediction process by using the prediction coefficient wᵣ, learned in the learning device 1 in FIG. 11.

The prediction device 81 in FIG. 13 is configured by the tap constructing unit 91, the tap constructing unit 92, the classification unit 93, the tap constructing unit 95, the predictive computation unit 96, and a coefficient memory 111.

Incidentally, in FIG. 13, components that are the same as those of the learning device 81 in FIG. 9 are denoted by the same reference numerals. That is, the prediction device 81 in FIG. 13 is provided with the coefficient memory 111 instead of the coefficient memory 94 of the prediction device 81 in FIG. 9.

In the coefficient memory 111, a prediction coefficient wₙ for each class, noise parameter Nz, noise parameter Ni, blur parameter P, and scaling parameters (H, V) stored in the coefficient memory 19 in FIG. 11 is stored. The coefficient memory 111 acquires a noise parameter Nz, a noise parameter Ni, a blur parameter P, and scaling parameters (H, V) that are specified by the user.

On the basis of the class supplied from the classification unit 93, and the noise parameter Nz, the noise parameter Ni, the blur parameter P, and the scaling parameters (H, V) specified by the user, the coefficient memory 111 reads a prediction coefficient wₙ corresponding to the class, the noise parameter Nz, the noise parameter Ni, the blur parameter P, and the scaling parameters (H, V), from among the prediction coefficients wₙ that have been already stored, and provides the prediction coefficient wₙ to the predictive computation unit 96.

Incidentally, since the prediction device 81 in FIG. 13 performs a prediction process similar to the prediction process in FIG. 10, description thereof is omitted. It should be noted, however, that in this case, in step S35 in FIG. 10, on the basis of the class supplied from the classification unit 93, and the noise parameter Nz, the noise parameter Ni, the blur parameter P, and the scaling parameters (H, V) specified by the user, the coefficient memory 111 reads a prediction coefficient wₙ corresponding to the class, the noise parameter Nz, the noise parameter Ni, the blur parameter P, and the scaling parameters (H, V), from among the prediction coefficients wₙ that have been already stored, and provides the prediction coefficient wₙ to the predictive computation unit 96.

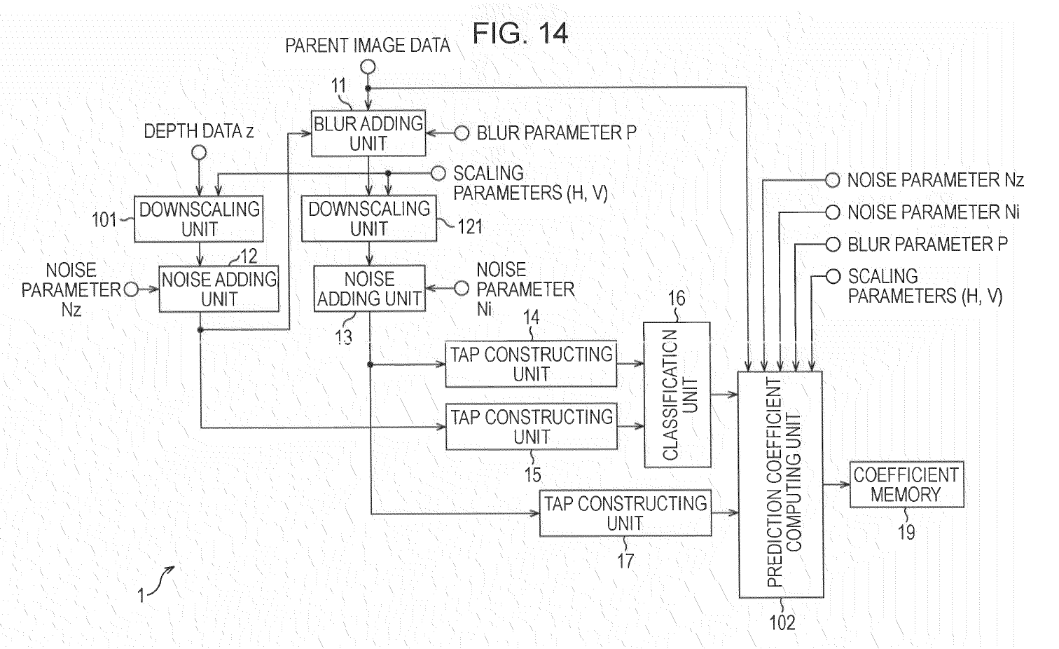

FIG. 14 is a block diagram showing the configuration of still another embodiment of the learning device 1.

The learning device 1 in FIG. 14 is configured by the blur adding unit 11, the noise adding unit 12, the noise adding unit 13, the tap constructing unit 14, the tap constructing unit 15, the classification unit 16, the tap constructing unit 17, the coefficient memory 19, the downscaling unit 101, the prediction coefficient computing unit 102, and a downscaling unit 121, and learns a prediction coefficient wₙ used when performing a prediction process of predicting, from a blurred image, a blur-corrected image with a higher resolution in comparison to the blurred image by a classification adaptive process.

Incidentally, in FIG. 14, components that are the same as those of the learning device 1 in FIG. 11 are denoted by the same reference numerals. That is, the learning device 1 in FIG. 14 has the downscaling unit 121 further provided to the learning device 1 in FIG. 11.

The downscaling unit 121 downscales student image data supplied from the blur adding unit 11 on the basis of scaling parameters (H, V) specified by the user, so that, for example, the size of a student image becomes the same as the size of a blurred image that is subjected to a prediction process, and supplies the downscaled student image data to the noise adding unit 13.

In the downscaling unit 101 in FIG. 14, the downscaling unit 101 downscales depth data z on the basis of the scaling parameters (H, V) so that, for example, the size of a parent image corresponding to a blur-corrected image with a higher definition in comparison to a blurred image becomes the same as the size of the blurred image.

Also, on the basis of parent image data supplied from an unillustrated device, and an image prediction tap constructed from student image data obtained after downscaling which is supplied from the tap constructing unit 17, the prediction coefficient computing unit 102 computes a prediction coefficient Wₙ for each class classified on the basis of a class tap constructed from student image data that has undergone downscaling, and a depth class tap constructed from depth data z that has undergone downscaling, and for each noise parameter Nz, noise parameter Ni, blur parameter P, and scaling parameters (H, V), and supplies the prediction coefficient Wₙ to the coefficient memory 19.

As described above, the learning device 1 in FIG. 14 performs downscaling with respect to student image data and depth data z. Thus, the resolution of a parent image corresponding to a student image and the depth data z can be transformed into a lower resolution relative to a parent image corresponding to parent image data inputted to the learning device 1 in FIG. 14. As a result, by using the student image and the depth data z that has undergone the transformation, and the parent image data, the learning device 1 in FIG. 14 can learn the prediction coefficient wₙ used in the prediction process of predicting, from a blurred image, a blur-corrected image with a higher resolution in comparison to the blurred image.

That is, for example, the learning device 1 in FIG. 14 can learn a prediction coefficient wₙ used in the prediction process of predicting a blur-corrected image that is an HD (High Definition) image, from a blurred image that is an SD (Standard Definition) image.

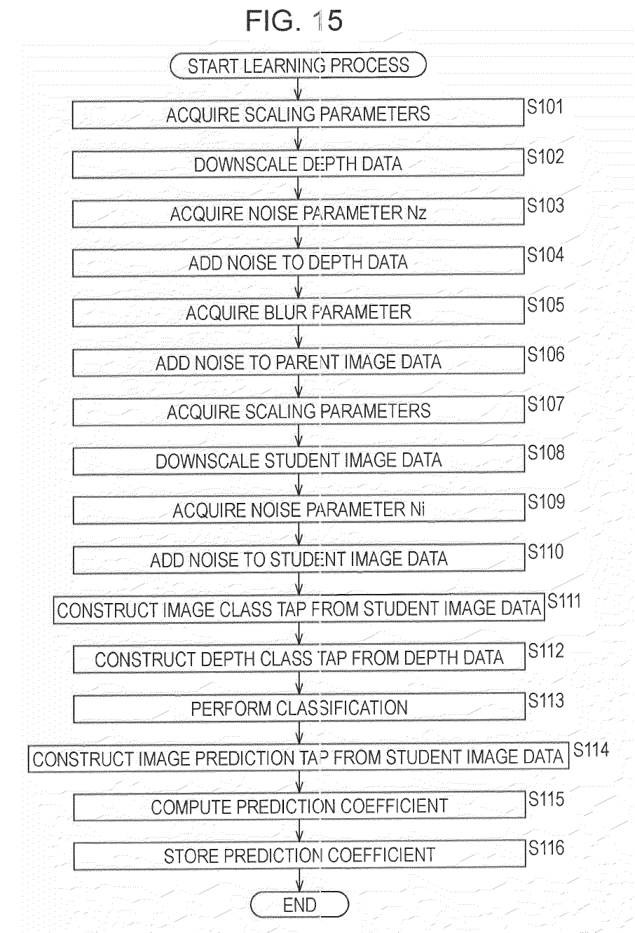

Next, referring to FIG. 15, a description will be given of a learning process in which the learning device 1 in FIG. 14 learns a prediction coefficient wₙ. This learning process is started when, for example, parent image data and depth data z are inputted to the learning device 1 in FIG. 14.

Since the processes from step S101 through step S106 are similar to the processes from step S61 to step S66 in FIG. 12, description thereof is omitted.

In step S107, the downscaling unit 121 acquires scaling parameters (H, V). In step S108, the downscaling unit 121 downscales student image data supplied from the blur adding unit 11 on the basis of scaling parameters (H, V), and supplies the downscaled student image data to the noise adding unit 13.

Since the processes from step S109 through step S116 are similar to the processes from step S67 to step S74, description thereof is omitted.

Incidentally, since the prediction device 81 that performs a prediction process by using the prediction coefficient wₙ learned in the learning device 1 in FIG. 14 is the same as the prediction device 81 in FIG. 13, description thereof is omitted.

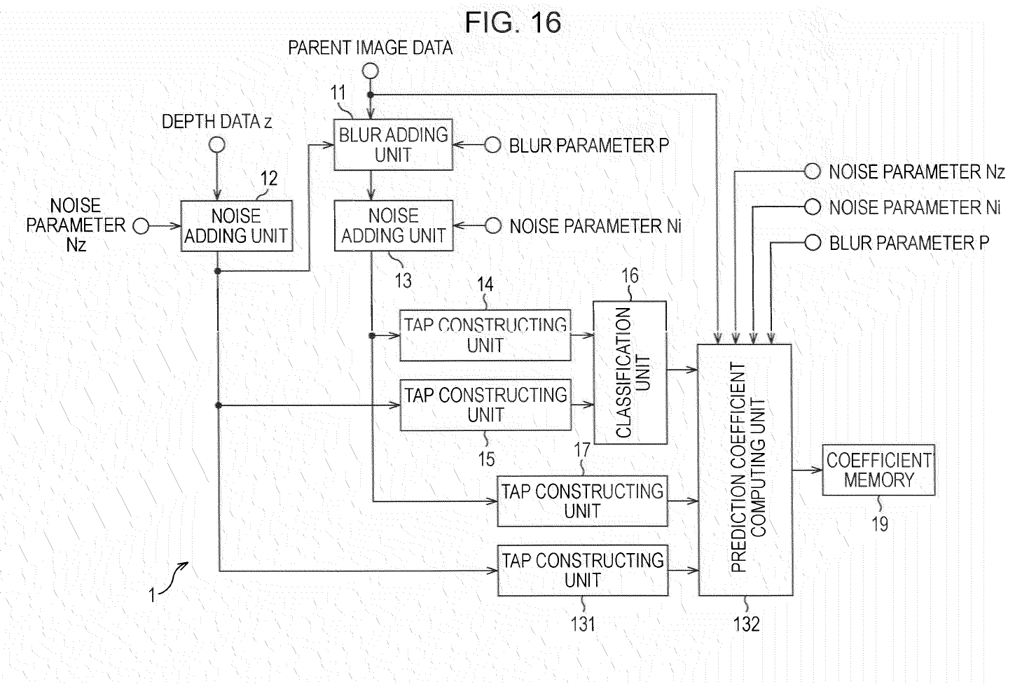

Also, for the computation of the prediction coefficient wₙ, not only pixels but also data other than pixels can be used as well. The configuration of the learning device 1 in a case where not only blurred pixels but also depth data z are used for the computation of the prediction coefficient wₙ is shown in FIG. 16.

The learning device 1 in FIG. 16 is configured by the blur adding unit 11, the noise adding unit 12, the noise adding unit 13, the tap constructing unit 14, the tap constructing unit 15, the classification unit 16, the tap constructing unit 17, the coefficient memory 19, a tap constructing unit 131, and a prediction coefficient computing unit 132, and learns a prediction coefficient wₙ used when performing the prediction process of predicting, from a blurred image and corresponding depth data z, a blur-corrected image of the same size by a classification adaptive process using depth data z in addition to parent image data and student image data.

Incidentally, in FIG. 16, components that are the same as those of the learning device 1 in FIG. 3 are denoted by the same reference numerals.

That is, in the learning device 1 in FIG. 16, the tap constructing unit 131 is further provided to the learning device 1 in FIG. 3, and the prediction coefficient computing unit 132 is provided instead of the prediction coefficient computing unit 18.

Depth data z that has undergone noise addition is supplied to the tap constructing unit 131 from the noise adding unit 12. The tap constructing unit 131 extracts, from the depth data z, several pieces of depth data z used for predicting the pixel value of a target pixel, thereby constructing a depth prediction tap.

The tap constructing unit 131 supplies the depth prediction tap to the prediction coefficient computing unit 132.

Like the prediction coefficient computing unit 18, the prediction coefficient computing unit 132 acquires a noise parameter Nz, a noise parameter Ni, and a blur parameter P that are specified by the user. Also, the prediction coefficient computing unit 132 computes a prediction coefficient wₙ for each class supplied from the classification unit 16, and for each noise parameter Nz, noise parameter Ni, and blur parameter P, on the basis of parent image data supplied from an unillustrated device, the image prediction tap supplied from the tap constructing unit 17, and the depth prediction tap supplied from the tap constructing unit 131.

Specifically, the prediction coefficient computing unit 132 computes prediction coefficients wₙ for the number of pixels corresponding to the image prediction tap and the depth prediction tap, for each class, noise parameter Nz, noise parameter Ni, and blur parameter P by using not only a blurred pixel of the k-th sample but also depth data z that constitutes the depth prediction tap, as x_{n,k} in the normal equation of Equation (8) described above which is set up for each class, noise parameter Nz, noise parameter Ni, and blur parameter P. The prediction coefficient computing unit 132 supplies the prediction coefficients wₙ for each class, noise parameter Nz, noise parameter Ni, and blur parameter P, which are obtained as a result of the computation, to the coefficient memory 19 to be stored therein.

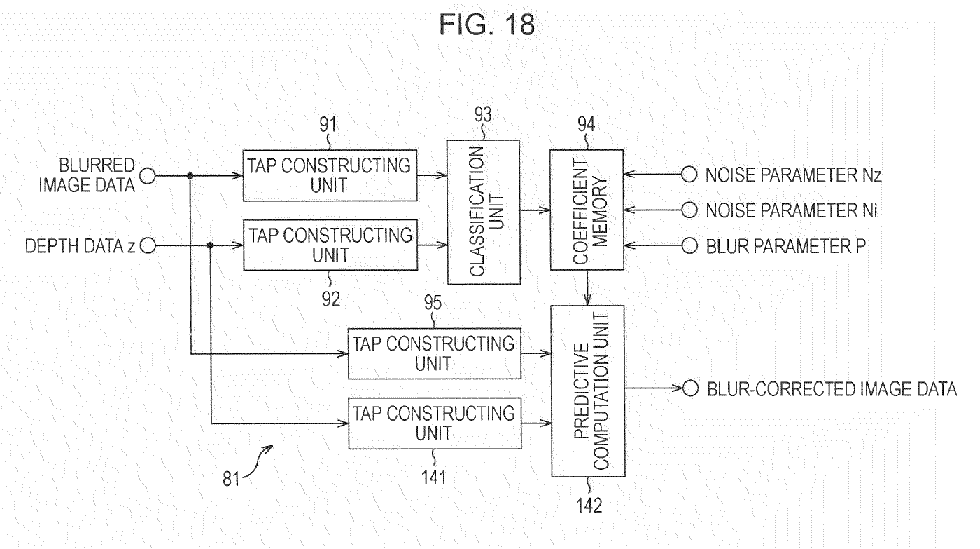

As described above, by also using a depth prediction tap constructed from depth data z, the learning device 1 in FIG. 16 computes prediction coefficients wₙ for the number of pixels corresponding to an image prediction tap and a depth prediction tap, which take the depth data z into consideration. Thus, by using the prediction coefficients wₙ, the prediction device 81 in FIG. 18 described later can predict a blur-corrected image more accurately.

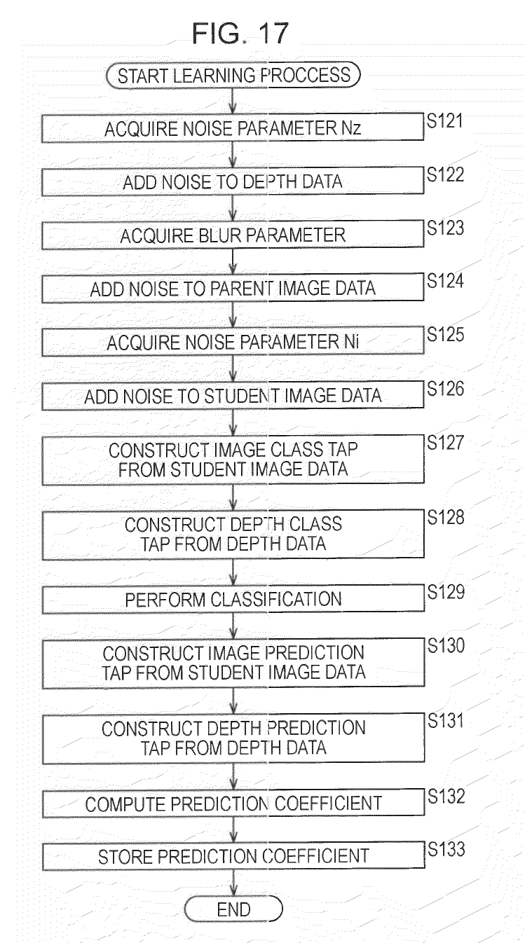

Next, referring to FIG. 17, a description will be given of a learning process in which the learning device 1 in FIG. 16 learns a prediction coefficient wₙ. This learning process is started when, for example, parent image data and depth data z are inputted to the learning device 1 in FIG. 16.

Since the processes from step S121 through step S130 are similar to the processes from step S1 to step S10 in FIG. 8, description thereof is omitted.

In step S131, the tap constructing unit 131 constructs a depth prediction tap by extracting predetermined pieces of depth data z having undergone noise addition supplied from the noise adding unit 12, and supplies the depth prediction tap to the prediction coefficient computing unit 132.

In step S132, on the basis of parent image data supplied from an unillustrated device, the image prediction tap supplied from the tap constructing unit 17, and the depth prediction tap supplied from the tap constructing unit 131, the prediction coefficient computing unit 132 computes a prediction coefficient Wₙ for each class supplied from the classification unit 16, and for each noise parameter Nz, noise parameter Ni, and blur parameter P, and supplies the prediction coefficient Wₙ to the coefficient memory 19.

In step S133, as in step S12 in FIG. 8, the coefficient memory 19 stores the prediction coefficient wₙ supplied from the prediction coefficient computing unit 132, and the processing ends.

FIG. 18 is a block diagram showing the configuration of the prediction device 81 that performs a prediction process using the prediction coefficient wₙ learned in the learning device 1 in FIG. 16.

The prediction device 81 in FIG. 18 is configured by the tap constructing unit 91, the tap constructing unit 92, the classification unit 93, the coefficient memory 94, the tap constructing unit 95, a tap constructing unit 141, and a predictive computation unit 142.

Incidentally, in FIG. 18, components that are the same as those of the learning device 81 in FIG. 9 are denoted by the same reference numerals. That is, in the prediction device 81 in FIG. 18, the tap constructing unit 141 is additionally provided, and the predictive computation unit 142 is provided instead of the predictive computation unit 96 of the prediction device 81 in FIG. 9.

Like the tap constructing unit 131 in FIG. 16, the tap constructing unit 141 extracts several pieces of depth data z used for predicting the pixel value of a target pixel, thereby constructing a depth prediction tap from the depth data z. The tap constructing unit 141 supplies the depth prediction tap to the predictive computation unit 142.

The predictive computation unit 142 performs a predictive computation for obtaining a predicted value of the pixel value of a target pixel, by using the image prediction tap supplied from the tap constructing unit 95, the depth prediction tap supplied from the tap constructing unit 141, and the prediction coefficient wₙ provided from the coefficient memory 94.

Specifically, the predictive computation unit 142 obtains the pixel values of pixels that constitute a blur-corrected image by applying, as xₙ of the linear first-order equation of Equation (1) described above, not only a blurred pixel that constitutes an image prediction tap but also depth data z that constitutes a depth prediction tap, and by applying, as wₙ, prediction coefficients for the number of pixels corresponding to the image prediction tap and the depth prediction tap learned in the learning device 1 in FIG. 16.

The predictive computation unit 142 outputs the pixel value of each pixel that constitutes a blur-corrected image as blur-corrected image data.

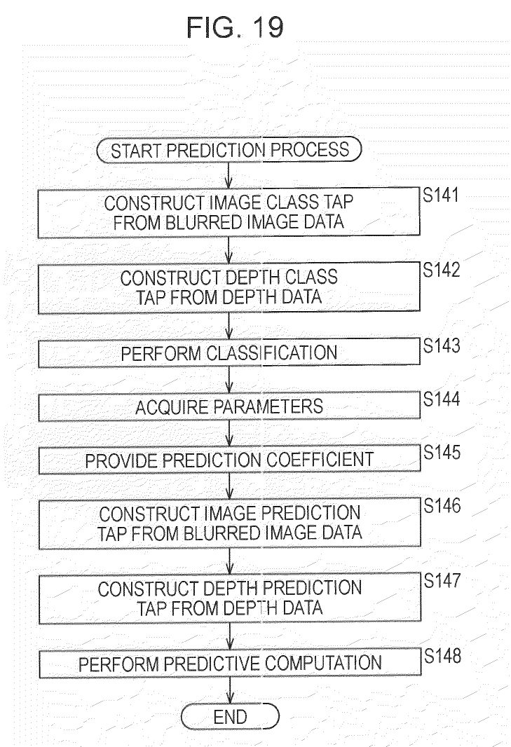

Next, referring to FIG. 19, a description will be given of a prediction process in which the prediction device 81 in FIG. 18 predicts blur-corrected image data. This prediction process is started when, for example, blurred image data and depth data z are inputted to the prediction device 81.

Since the processes from step S141 through step S146 are similar to the processes from step S31 to step S36 in FIG. 10, description thereof is omitted.

In step S147, the tap constructing unit 141 constructs a depth prediction tap from depth data z, and supplies the depth prediction tap to the predictive computation unit 142. In step S148, by using the image prediction tap supplied from the tap constructing unit 95, the depth prediction tap supplied from the tap constructing unit 141, and the prediction coefficient wₙ provided from the coefficient memory 94, the predictive computation unit 142 performs a predictive computation for obtaining a predicted value of the pixel value of a target pixel, obtains the pixel value of each pixel that constitutes a blur-corrected image, and outputs the pixel value as blur-corrected image data. Then, the processing ends.

The noise described in the foregoing can be considered to include a fluctuation added to a parameter. Here, a fluctuation includes a variation of a quantity with a spread or intensity, such as energy, density, or voltage, from the spatial or temporal average value. While a function that gives a fluctuation is arbitrary, by setting it as a 1/f fluctuation in which the power is inversely proportion to the frequency f, it is possible to generate an image added with an effect that makes the image change more naturally.

A 1/f fluctuation can be generated by performing a Fourier transform on noise SWN, processing the power spectrum to 1/f in frequency domain, and performing an inverse Fourier transform. The power spectrum with respect to a variation in the time direction of a noise amplitude added to a parameter is set to 1/f, and 1/f fluctuations are added individually to the parameters of individual pixels. With regard to a frame as well, the power spectrum with respect to a variation in the time direction is set to 1/f.

Next, a description will be given of a process of generating an image to which noise as a fluctuation in this sense is added. In an embodiment of the present invention, a noise-added image is generated by giving noise to blur data of a blur model set in advance.

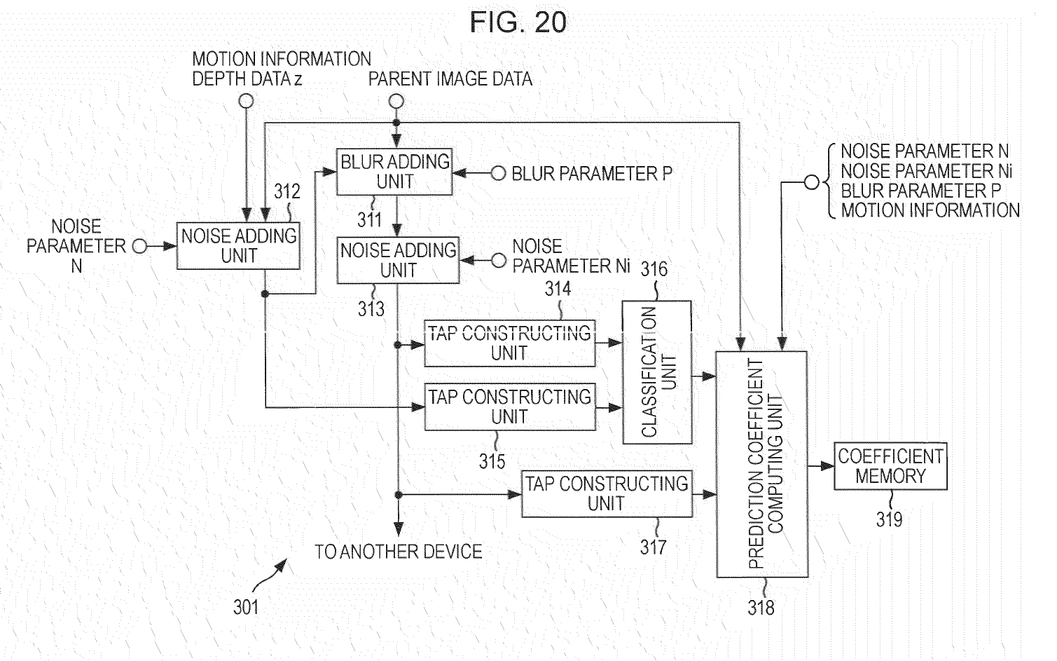

FIG. 20 is a block diagram showing the configuration of an embodiment of an image generating device that generates the image data of a noise-added image. The basic configuration of this image generating device 301 is similar to that of the learning device 1 in FIG. 3, and a blur adding unit 311, a noise adding unit 312, a noise adding unit 313, a tap constructing unit 314, a tap constructing unit 315, a classification unit 316, a tap constructing unit 317, a prediction coefficient computing unit 318, and a coefficient memory 319 have functions similar to the blur adding unit 11, the noise adding unit 12, the noise adding unit 13, the tap constructing unit 14, the tap constructing unit 15, the classification unit 16, the tap constructing unit 17, the prediction coefficient computing unit 18, and the coefficient memory 19 in FIG. 3. Therefore, description thereof is omitted.

It should be noted, however, that in this embodiment, not only depth data z but also motion information and parent image data are supplied to the noise adding unit 312 and, in addition, a noise parameter N is supplied instead of a noise parameter Nz. Also, in addition to a noise parameter Ni and a blur parameter P, a noise parameter N and motion information are supplied to the prediction coefficient computing unit 318.

In addition to having a function of generating the image data of a noise-added image, the image generating device 301 has a function of learning prediction coefficients in the case of performing a process of correcting noise from a noise-added image. That is, the image generating device 301 has a function as an image data generating device, and a function as a prediction coefficient computing device. Thus, in addition to being outputted to another device as the image data of a noise-added image, image data generated by the noise adding unit 313 is supplied as student image data to the tap constructing unit 314 and the tap constructing unit 317.

The noise-added image is generated as a blurred image by adding a noise component to the in-focus state or motion of an image.

Incidentally, an image generating device that generates the image data of a noise-added image may conceivably take a configuration corresponding to the learning device shown in FIG. 14. An embodiment in this case is shown in FIG. 21.

The basic configuration of this image generating device 400 is similar to that of the learning device 1 in FIG. 14. That is, a blur adding unit 311, a noise adding unit 312, a noise adding unit 313, a tap constructing unit 314, a tap constructing unit 315, a classification unit 316, a tap constructing unit 317, a prediction coefficient computing unit 402, a coefficient memory 319, a downscaling unit 401, a prediction coefficient computing unit 402, and a downscaling unit 421 in FIG. 21 have functions similar to the blur adding unit 11, the noise adding unit 12, the noise adding unit 13, the tap constructing unit 14, the tap constructing unit 15, the classification unit 16, the tap constructing unit 17, the coefficient memory 19, the downscaling unit 101, the prediction coefficient computing unit 102, and the downscaling unit 121 in FIG. 14. Therefore, description thereof is omitted.

It should be noted, however, that in addition to depth data z and scaling parameters (H, V), motion information and parent image data are supplied to the downscaling unit 401. Instead of a noise parameter Nz, a noise parameter N is supplied to the noise adding unit 312. Also, in addition to a noise parameter Ni, a blur parameter P, and scaling parameters (H, V), motion information is supplied to the prediction coefficient computing unit 402, and a noise parameter N is supplied instead of a noise parameter Nz.

Addition of noise with respect to an in-focus state (out-of-focus blur noise) is performed by adding noise to distance information, the deviation a of a Gaussian function of blur, the phase of a Gaussian function of blur, or the sharpness of a Gaussian function of blur, or by a composite of predetermined ones of them.

In the case of giving noise to an in-focus state on the basis of distance information, noise is added to depth data z as blur data. That is, letting depth data that has undergone noise addition be Zswn, and the noise to be added be SWNd, as indicated by the following equation, the depth data Zswn after noise addition is computed by adding the noise SWNd to the depth data z that has not undergone noise addition.

Zswn=z+SWNd (21)

As indicated by the following equation, the noise SWNd is represented as the sum of a component SWNd(frame) that is varied on a frame-by-frame basis, and a component SWNd(pixel) that is varied on a pixel-by-pixel basis.

SWNd=SWNd(frame)+SWNd(pixel) (22)

Then, the noise SWNd can be represented by, for example, the following equation. This function mseq generates a pseudo-random number.

RΣmseq[m] (23)

m=0, 1, 2, . . . n

Letting each component that varies on a frame-by-frame basis be RΣmseq[m](frame), and each component that varies on a pixel-by-pixel basis be RΣmseq[m](pixel), the noise SWNd is represented by the following equation. Incidentally, the suffix d on the right side of the following equation indicates that a coefficient R or a function mseq is related to the distance.

SWNd=R_{d}Σmseq_{d}[m](frame)+R_{d}Σmseq_{d}[m](pixel) (24)

Then, a coefficient Rd as a parameter that determines the noise SWNd is set in correspondence to the noise parameter N.

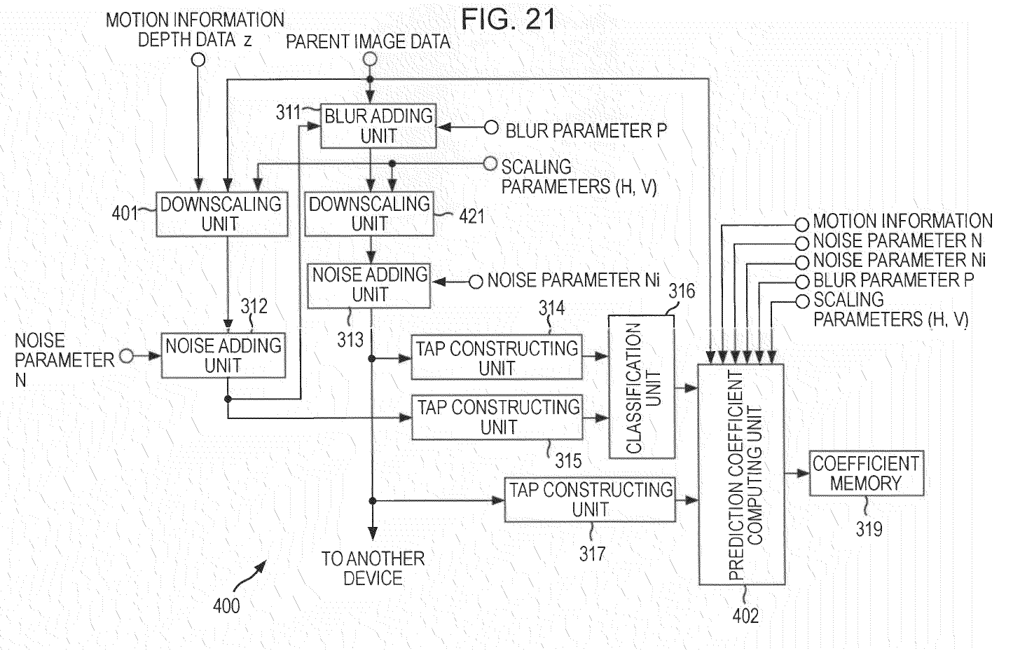

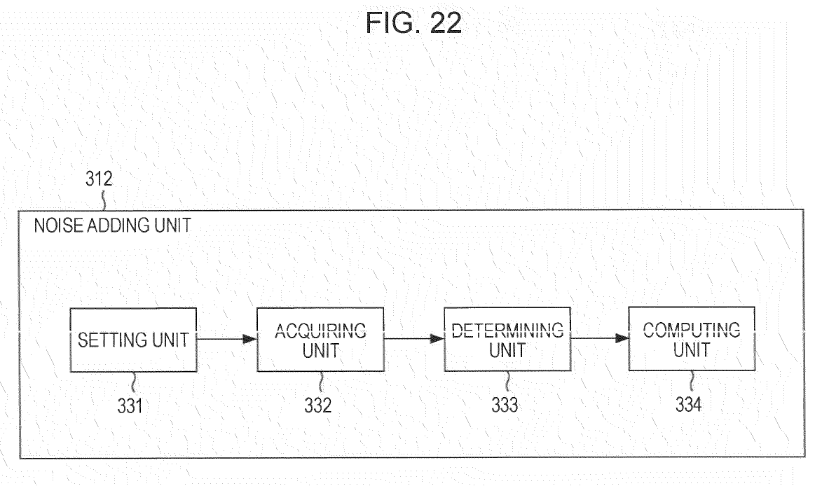

To execute the above processing, as shown in FIG. 22, the noise adding unit 312 has the functional components of a setting unit 331, an acquiring unit 332, a determining unit 333, and a computing unit 334.

The setting unit 331 sets a processing area on the basis of a user's instruction. The acquiring unit 332 acquires a noise parameter N and motion information. The determining unit 333 determines a coefficient in an equation for noise. The computing unit 334 performs various computations including noise.

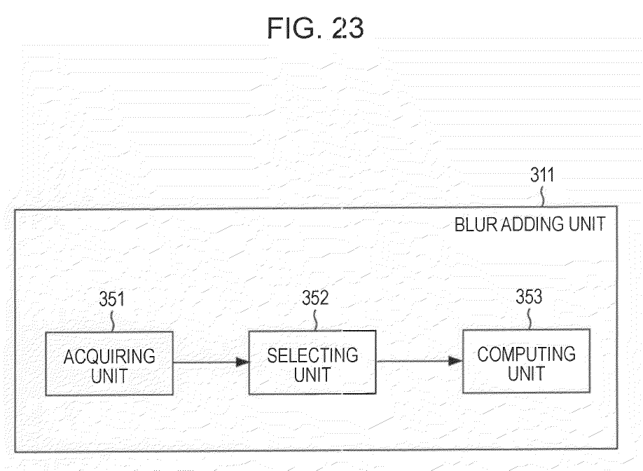

Also, as shown in FIG. 23, the blur adding unit 311 has the functional components of an acquiring unit 351, a selecting unit 352, and a computing unit 353.

The acquiring unit 351 acquires a blur parameter P. The selecting unit 352 selects a weight wᵢ. The computing unit 353 performs various computations.

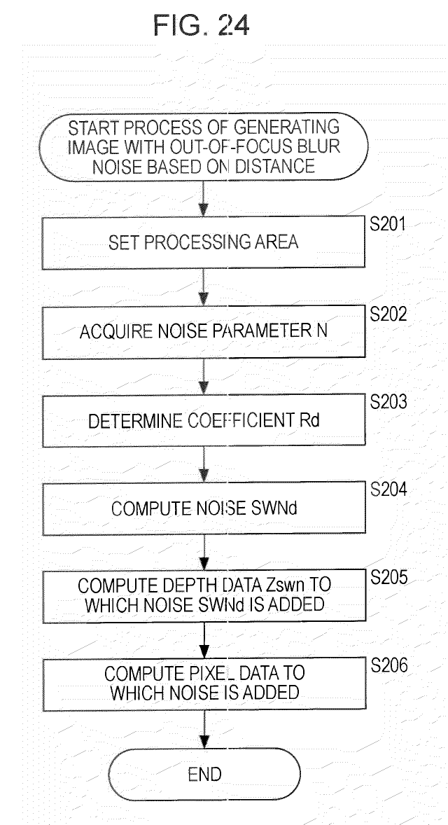

A description will be given of a process of generating an image with out-of-focus blur noise on the basis of distance information, with reference to the flowchart in FIG. 24.

In step S201, the setting unit 331 sets a processing area on the basis of a user's instruction. In this case, the user can set a part or the entirety of an image as the processing area. This process can be omitted in a case where the entirety of an image is always processed. In step S202, the acquiring unit 332 acquires a noise parameter N specified by the user. In step S203, the determining unit 333 determines the coefficient Rd of the noise SWNd in Equation (24), in correspondence to the noise parameter N.

In step S204, the computing unit 334 computes the noise SWNd. That is, the noise SWNd is computed in accordance with Equation (24).

In step S205, the computing unit 334 computes depth data with the noise SWNd added thereto, with respect to the set processing area. Specifically, in accordance with Equation (21), the noise SWNd computed in step S204 is added to acquired depth data z, and depth data Zswn after addition of the noise SWNd is computed. This depth data Zswn with the noise SWNd added thereto is outputted to the blur adding unit 311 as a parameter that gives noise to a blur model.

In step S206, the computing unit 353 of the blur adding unit 311 computes noise-added pixel data. That is, in the blur adding unit 311, as described above, the point spread function WT(k, l) of blur of Equation (19) as a blur model is computed on the basis of the noise-added depth data Zswn, blur is added to parent image data on the basis of Equation (18), and a still image whose in-focus state has fluctuated is generated. This noise differs for each frame, and also differs for each pixel.

Therefore, when a plurality of frames of images are generated while varying noise components on a frame-by-frame basis and on a pixel-by-pixel basis with respect to one still image, a kind of animation in which one image appears to fluctuate can be generated. Thus, for example, it is possible to generate an image whose relatively detailed original state can be recognized as it is, and has an effect of fluctuating naturally due to variations in the temperature or humidity of the ambient air, or the like, such as one observed when a person sees an object in the air from afar.

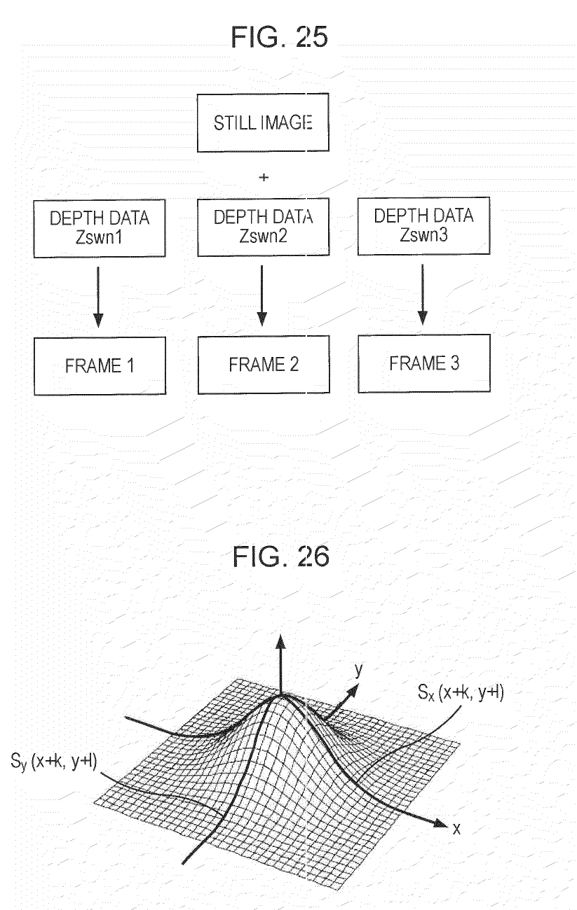

That is, by performing the above processing, as shown in, for example, FIG. 25, by processing one still image on the basis of depth data Zswn1, Zswn2, Zswn3 to which mutually different noises SWNdᵢ (i=1, 2, 3) are added, images of Frame 1 through Frame 3 that slightly differ from the original still image can be generated.

It is also possible to give noise with respect to an in-focus state on the basis of the deviation a of the Gaussian function as a blur function. In this case, when the x-direction component Sₓ(x+k, y+l) and y-direction component S_{y}(x+k, y+l) of a function S(x+k, y+l) corresponding to the deviation a as blur data of Equation (19) as a blur model are made independent, Equation (19) can be rewritten as the following equation.

$$\begin{matrix}[ Eq . 13 ] & \\ WT ( k , 1 ) = \frac{1}{2 π {S}_{x} ( x + k , y + 1 ) {S}_{y} ( x + k , y + 1 )} {e}^{- \frac{( {k}^{2} + {1}^{2} )}{\begin{matrix}2 {S}_{x} ( x + k , y + 1 ) \\ {S}_{y} ( x + k , y + 1 )\end{matrix}}} & ( 25 )\end{matrix}$$

Noise is independently given to the functions Sₓ(x+k, y+l), S_{y}(x+k, y+l) as this blur data. That is, letting the x component and y component of noise SWNs be SWNsx, SWNsy, respectively, the functions S_{xswn}(x+k, y+l)^{, S}_{yswn}(x+k, y+l) that have undergone noise addition are computed by the following equations.

S_{xswn}(x+k,y+l)=Sₓ(x+k,y+l)+SWNsx

S_{yswn}(x+k,y+l)=S_{y}(x+k,y+l)+SWNsy (26)

The fact that the functions Sₓ(x+k, y+l), S_{y}(x+k, y+l) are independent means that when the two functions are illustrated as shown in FIG. 26, upon rotating one of the functions along the axis of the other function, the shapes of the two functions do not coincide with each other.

In this case as well, letting an x component and a y component that are varied on a frame-by-frame basis be SWNsx(frame), SWNsy(frame), and an x component and a y component that are varied on a pixel-by-pixel basis be SWNsx(pixel), SWNsy(pixel), the x component SWNsx and y component SWNsy of the noise SWNs are represented by the following equations.

SWNsx=SWNsx(frame)+SWNsx(pixel)

SWNsy=SWNsy(frame)+SWNsy(pixel) (27)

Then, a point spread function WT(k, l)swn of blur is computed by the following equation obtained by replacing the functions Sₓ(x+k, y+l), S_{y}(x+k, y+l) of Equation (25) by functions S_{xswn}(x+k, y+l), S_{yswn}(x+k, y+l) obtained by adding the x component SWNsx and y component SWNsy of the noise SWNs to the above equations. By using this point spread function WT(k, l)swn of blur, image data Y(x, y) is computed in accordance with Equation (18).

$$\begin{matrix}[ Eq . 14 ] & \\ {WT ( k , 1 )}_{swn} = \frac{1}{\begin{matrix}2 π {S}_{xswn} ( x + k , y + 1 ) \\ {S}_{yswn} ( x + k , y + 1 )\end{matrix}} {e}^{- \frac{( {k}^{2} + {1}^{2} )}{\begin{matrix}2 {S}_{xswn} ( x + k , y + 1 ) \\ {S}_{yswn} ( x + k , y + 1 )\end{matrix}}} & ( 28 )\end{matrix}$$

For example, let the noise SWNs be represented by Equation (23) described above. Then, letting each component that varies on a frame-by-frame basis be RΣmseq[m] (frame), and each component that varies on a pixel-by-pixel basis be RΣmseq[m] (pixel), the x component SWNsx and y component SWNsy of the noise SWNs are represented by the following equations.

SWNsx=R_{Sx}Σmseq_{Sx}[m](frame)+R_{Sx}Σmseq_{Sx}[m](pixel)

SWNsy=R_{Sy}Σmseq_{Sy}[m](frame)+R_{Sy}Σmseq_{Sy}[m](pixel) (29)

Then, by determining the coefficients R_{Sx}, R_{Sy} in accordance with a noise parameter N, the values of the noises SWNsx, SWNsy are determined. Functions S_{xswn}(x+k, y+l), S_{yswn}(x+k, y+l) with the noises SWNsx, SWNsy added thereto are supplied to the blur adding unit 311 as parameters that give noise in a blur model.

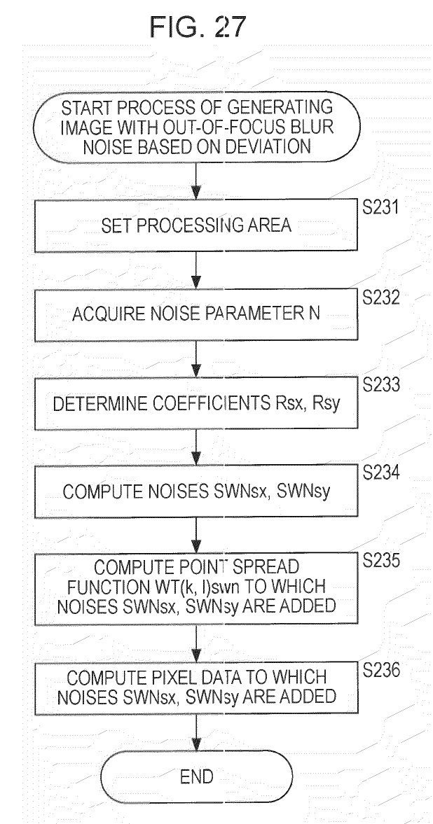

A procedure for the process of generating an image with out-of-focus blur noise based on deviation will be described with reference to the flowchart in FIG. 27.

In step S231, the setting unit 331 sets a processing area on the basis of a user's instruction. In this case, the user can set a part or the entirety of an image as the processing area. This process can be omitted in a case where the entirety of an image is always processed. In step S232, the acquiring unit 332 acquires a noise parameter N specified by the user. In step S233, the determining unit 333 determines the coefficients R_{Sx}, R_{Sy} in Equation (29) on the basis of the noise parameter N.

In step S234, the computing unit 334 computes the noises SWNsx, SWNsy. That is, on the basis of the coefficients R_{Sx}, R_{Sy} corresponding to the noise parameter N acquired in step S232, the noises SWNsx, SWNsy are computed from Equation (29).

In step S235, the computing unit 334 computes a point spread function WT(k, l)swn of blur to which the noises SWNsx, SWNsy are added. That is, a point spread function WT(k, l)swn of blur to which the noises SWNsx, SWNsy computed in step S234 are added is computed in accordance with Equation (28). This point spread function WT(k, l)swn of blur to which the noises SWNsx, SWNsy are added is outputted to the blur adding unit 311 as a parameter that gives noise to a blur model.

In step S236, the computing unit 353 of the blur adding unit 311 computes pixel data with the noises SWNsx, SWNsy added thereto, with respect to the set processing area. Specifically, parent image data X(x+k, y+l) is acquired, and with respect to the acquired parent image data X(x+k, y+l), pixel data Y(x, y) is computed in accordance with Equation (18) by using the point spread function WT(k, l)swn of blur with the noises SWNsx, SWNsy added thereto which is computed in step S235.

Noise components that differ for each frame, or differ for each pixel are added to individual pixels of the image of image data generated in this way. Therefore, when a plurality of frames of images are generated while varying noise components on a frame-by-frame basis and on a pixel-by-pixel basis with respect to one still image, a kind of animation in which one image appears to fluctuate can be generated.

That is, in this case as well, as in the case described above, it is possible to generate an image whose relatively detailed original state can be recognized as it is, and has an effect of fluctuating naturally due to variations in the temperature or humidity of the ambient air, or the like, such as one observed when a person sees an object in the air from afar.

By adding noise to the phase of the point spread function WT(k, l) of blur that defines a blur model, noise with respect to an in-focus state can be added to an image. In this case, noises SWNk(x, y), SWNl(x, y) are added to the x component k and the y component l as the blur data of the point spread function WT(k, l) of blur, and an x component kswn and a y component lswn that have undergone noise addition are as represented by the following equations.

kswn=k+SWNk(x,y)

lswn=l+SWNl(x,y) (30)

By substituting Equation (30), Equation (19) can be rewritten as in the following equation.

$$\begin{matrix}[ Eq . 15 ] & \\ {WT ( k , 1 )}_{swn} = \frac{1}{2 π {S}^{2} ( x + k , y + 1 )} {e}^{- \frac{{k}_{swn}^{2} + {1}_{swn}^{2}}{2 {S}^{2} ( x + k , y + 1 )}} & ( 31 )\end{matrix}$$

As indicated by the following equations, the noises SWNk(x, y), SWNl(x, y) are also constituted by the sums of noise components SWNk(x, y) (frame), SWNl(x, y) (frame) on a frame-by-frame basis, and noise components SWNk(x, y) (pixel), SWNl(x, y) (pixel) on a pixel-by-pixel basis.

SWNk(x,y)=SWNk(x,y)(frame)+SWNk(x,y)(pixel)

SWNl(x,y)=SWNl(x,y)(frame)+SWNl(x,y)(pixel) (32)

Let the noises SWNk(x, y), SWNl(x, y) be represented by Equation (23) described above. Then, letting each component that is varied on a frame-by-frame basis be RₖΣmseqₖ[m] (frame), RₗΣmseqₗ[m] (frame), and each component that is varied on a pixel-by-pixel basis be RₖΣmseqₖ [m] (pixel), RₗΣmseqᵢ [m] (pixel), the noises SWNk(x, y), SWNl(x, y) are represented by the following equations.

SWNk(x,y)=RₖΣmseqₖ[m](frame)+RₖΣmseqₖ[m](pixel)

SWNl(x,y)=RₗΣmseqₗ[m](frame)+RₗΣmseqₗ[m](pixel) (33)

Then, the coefficients Rₖ, Rₗ of the noises SWNk(x, y), SWNl(x, y) are determined in correspondence to a noise parameter N.

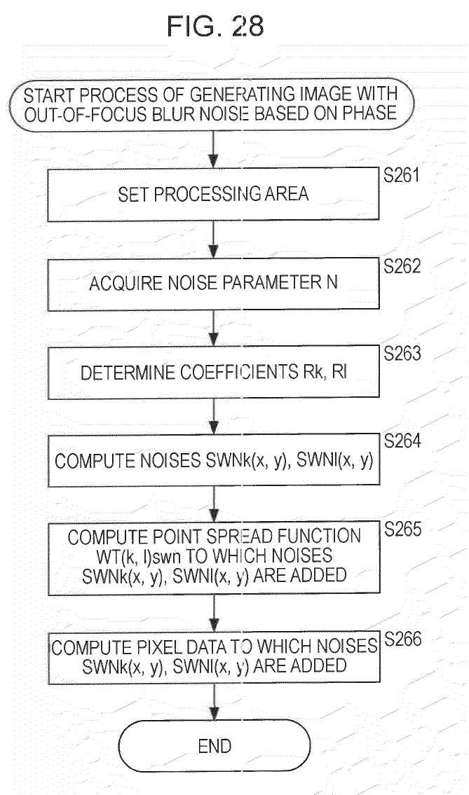

A procedure for the process of generating an image with out-of-focus blur noise based on phase will be described with reference to the flowchart in FIG. 28.

In step S261, the setting unit 331 sets a processing area on the basis of a user's instruction. In this case, the user can set a part or the entirety of an image as the processing area. This process can be omitted in a case where the entirety of an image is always processed. In step S262, the acquiring unit 332 acquires a noise parameter N specified by the user. In step S263, the determining unit 333 determines the coefficients Rₖ, Rₗ of the noises SWNk(x, y), SWNl(x, y) in Equation (33) on the basis of the noise parameter N.

In step S264, the computing unit 334 computes the noises SWNk(x, y), SWNl(x, y). That is, on the basis of the coefficients Rₖ, Rₗ corresponding to the noise parameter N acquired in step S262, the noises SWNk(x, y), SWNl(x, y) are computed from Equation (33).

In step S265, the computing unit 334 computes a point spread function WT(k, l)swn of blur to which the noises SWNk(x, y), SWNl(x, y) are added. That is, a point spread function WT(k, l)swn of blur to which the noises SWNk(x, y), SWNl(x, y) computed in step S264 are added is computed in accordance with Equation (31). This point spread function WT(k, l)swn of blur to which the noises SWNk(x, y), SWNl(x, y) are added is outputted to the blur adding unit 311, as a parameter that gives noise in a blur model.

In step S266, the computing unit 353 of the blur adding unit 311 computes pixel data with the noises SWNk(x, y), SWNl(x, y) added thereto, with respect to the set processing area. Specifically, from inputted parent image data X(x+k, y+l), pixel data Y(x, y) is computed in accordance with Equation (18) by using the point spread function WT(k, l)swn of blur with the noises SWNk(x, y), SWNl(x, y) added thereto which is computed in step S265.

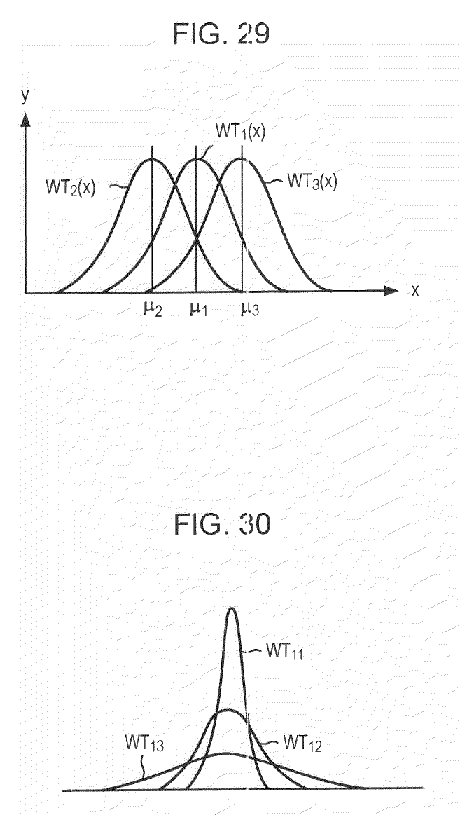

As shown in FIG. 29, in a case where, for example, a value on the x coordinate that gives a peak value of a point spread function WT₁ of blur which is represented by the x coordinate is μ₁, giving noise to the phase as described above means a shift to a function WT₂, WT₃ in a phase in which the x coordinate that gives the peak value is μ₂ or μ₃.

In this case as well, as in the case described above, it is possible to generate an image having an effect of fluctuating naturally.

By adding noise to the sharpness of a point spread function WT(k, l) of blur as a blur model, noise with respect to an in-focus state can be added to an image. In FIG. 30, a function WT₁₁ with the highest sharpness, a function WT₁₂ with an intermediate sharpness, and a function WT₁₃ with the lowest sharpness are shown. The sharpness can be made lower by making the intervals of sampling points in Equation (19) dense, and can be made higher by making the intervals coarse.

In a case where the total of coefficient values does not become 1.0, normalization is performed by dividing individual coefficient values by the sum total of coefficients.

That is, by combining a plurality of normal distributions computed with different deviations σ, and performing level normalization, characteristics (that is, equations) with varied sharpness can be obtained. Addition characteristics of different deviations σ are computed with respect to a target pixel, and after integrating them, level normalization is performed. A state in which the sharpness varies can be considered to be equivalent to a state in which noise is occurring in the depth direction (that is, in the distance direction) within one pixel (that is, a state in which a motion has occurred forward and backward within the integration time for one pixel). In this case, the point spread function of blur is represented by the following equation of a mixed normal distribution.

$$\begin{matrix}[ Eq . 16 ] & \\ WT ( k , 1 ) = {\sum }_{p = 1}^{m} {K}_{p} \cdot \frac{1}{2 π {S}^{2} ( x + k , y + 1 )} {e}^{- \frac{( {k}^{2} + {1}^{2} )}{2 {S}^{2} ( x + k , y + 1 )}} & ( 34 )\end{matrix}$$

By changing a coefficient Kp as blur data in the above equation to a coefficient Kpswn to which noise is given, the above equation can be rewritten as follows.

$$\begin{matrix}[ Eq . 17 ] & \\ {WT ( k , 1 )}_{swn} = {\sum }_{p = 1}^{m} {K}_{PSWN} \cdot - \frac{1}{2 π {S}^{2} ( x + k , y + 1 )} {e}^{- \frac{( {k}^{2} + {1}^{2} )}{2 {S}^{2} ( x + k , y + 1 )}} & ( 35 )\end{matrix}$$

Let noise be SWNp, the coefficient Kpswn to which noise is given is represented by the following equation.

$$\begin{matrix}[ Eq . 18 ] & \\ {K}_{PSWN} = \frac{{K}_{p}^{′}}{{\sum }_{p = 1}^{m} {K}_{p}^{′}} & ( 36 ) \\ {K}_{p}^{′} = {SWN}_{p} & ( 37 )\end{matrix}$$

Letting the noise SWNp be represented by Equation (23), and letting each component that varies on a frame-by-frame basis be RₚΣmseqₚ [m](frame), and each component that varies on a pixel-by-pixel basis be RₚΣmseqₚ [m] (pixel), a noise SWNp(x, y) is represented by the following equation.

SWNp(x,y)=RₚΣmseqₚ[m](frame)+RₚΣmseqₚ[m](pixel) (38)

Then, a coefficient Rₚ of the noise SWNp(x, y) is set in correspondence to a noise parameter N.

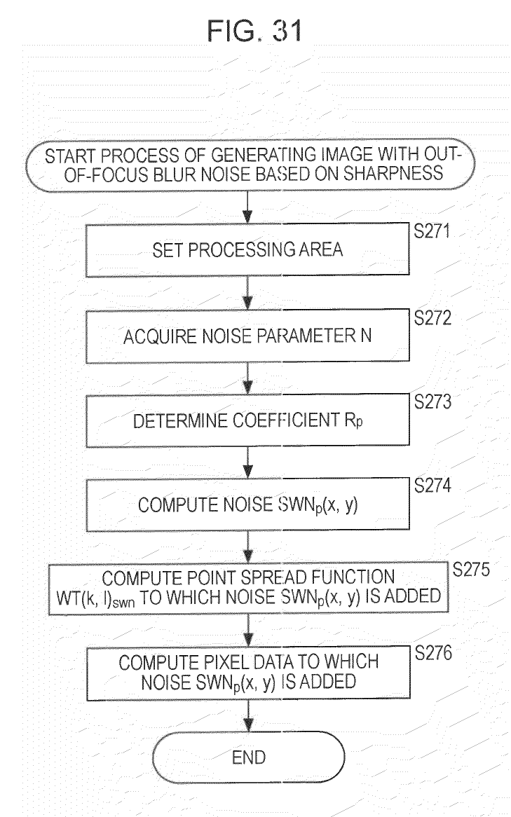

A procedure of the process of generating an image with out-of-focus blur noise based on sharpness will be described with reference to the flowchart in FIG. 31.

In step S271, the setting unit 331 sets a processing area on the basis of a user's instruction. In this case, the user can set a part or the entirety of an image as the processing area. This process can be omitted in a case where the entirety of an image is always processed. In step S272, the acquiring unit 332 acquires a noise parameter N specified by the user. In step S273, the determining unit 333 determines the coefficient Rₚ of the noise SWNp(x, y) in Equation (38) on the basis of the noise parameter N.

In step S274, the computing unit 334 computes the noise SWNp(x, y). That is, on the basis of the coefficient Rₚ corresponding to the noise parameter N acquired in step S272, the noise SWNp(x, y) is computed from Equation (38).

In step S275, the computing unit 334 computes a point spread function WT(k, l)swn of blur to which the noise SWNp(x, y) is added. That is, a point spread function WT(k, l)swn of blur to which the noise SWNp(x, y) computed in step S274 is added is computed in accordance with Equation (35). This point spread function WT(k, l)swn of blur to which the noise SWNp(x, y) is added is outputted to the blur adding unit 311, as a parameter that gives noise to a blur model.

In step S276, the computing unit 353 of the blur adding unit 311 computes pixel data with the noise SWNp(x, y) added thereto, with respect to the set processing area. Specifically, from inputted parent image data X(x+k, y+l), pixel data Y(x, y) is computed in accordance with Equation (18) by using the point spread function WT(k, l)swn of blur with the noise SWNp(x, y) added thereto which is computed in step S275.

In a case where noise is given to the sharpness as mentioned above as well, as in the case described above, it is possible to generate an image having an effect of fluctuating naturally.

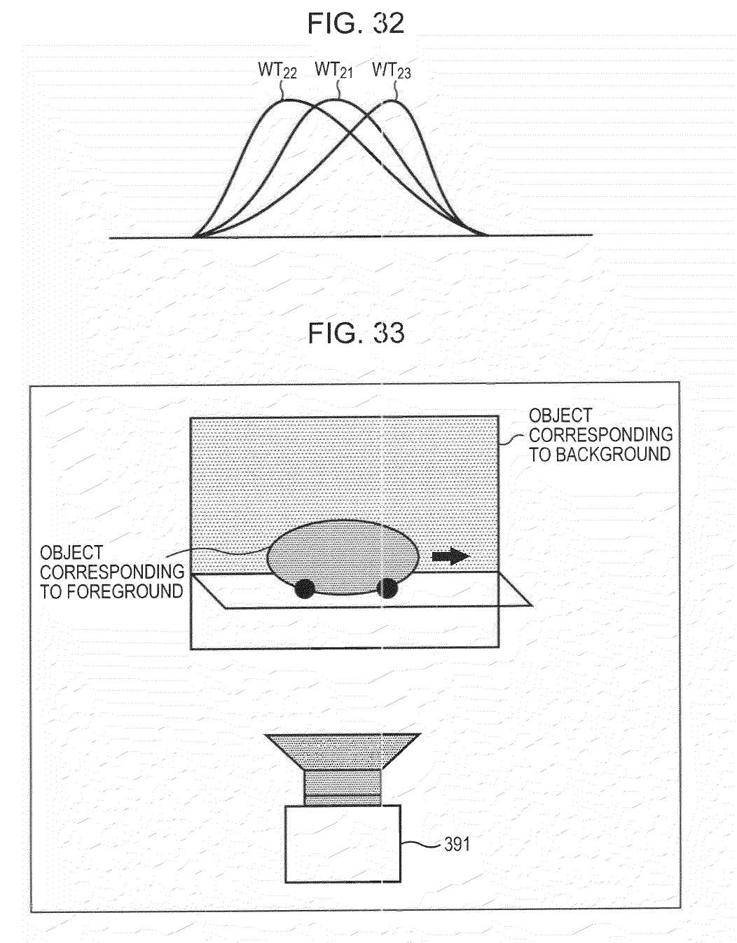

Further, as shown in FIG. 32, noise with respect to an in-focus state can be added to an image also by changing the point spread function WT(k, l) of blur of Equation (19) as a blur model to functions WT₂₂, WT₂₃ that are distorted from a Gaussian function WT₂₁.

Next, a description will be given of the case of generating an image to which noise of motion blur is added.

In a case where the foreground of a predetermined object moves in front of the background that is in a stationary state, upon capturing this by a sensor, a pixel that captures only the background, a pixel that captures only the foreground, and a pixel that captures a mixture of the foreground and the background appear. This will be discussed in detail below.

FIG. 33 is a diagram illustrating image capture by a sensor. A sensor 391 is constituted by, for example, a CCD video camera equipped with a CCD (Charge-Coupled Device) area sensor that is a solid-state image capturing element. An object corresponding to the foreground in the real world moves horizontally from the left side to the right side in the drawing, for example, between an object corresponding to the background in the real world and the sensor 391.

The sensor 391 constituted by, for example, a video camera or the like captures the object corresponding to the foreground, together with the object corresponding to the background. The sensor 391 outputs the captured image in 1-frame units. For example, the sensor 391 outputs an image made up of 30 frames per second. The exposure time of the sensor 391 can be set to 1/30 second. The exposure time is a period from when the sensor 391 starts converting inputted light into electrical charge until when the conversion of the inputted light into the electrical charge is finished. The exposure time is also referred to as shutter time.

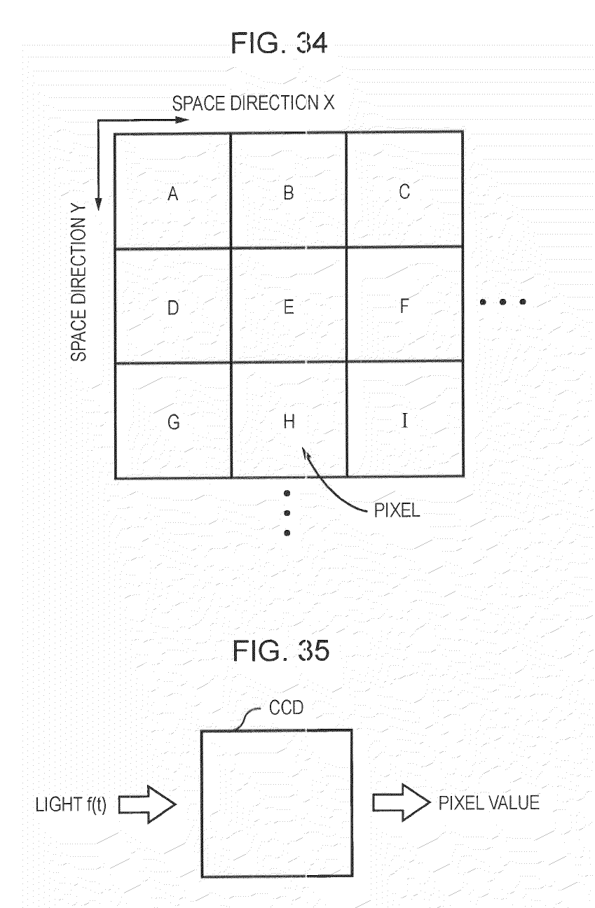

FIG. 34 is a diagram illustrating the arrangement of pixels. In FIG. 34, A through I indicate individual pixels. The pixels are arranged on a plane corresponding to an image. One detection element corresponding to one pixel is arranged on the sensor 391. When the sensor 391 captures an image, one detection element outputs a pixel value corresponding to one pixel that constitutes the image. For example, the position of a detection element in the X direction corresponds to a position in the transverse direction on the image, and the position of a detection element in the Y direction corresponds to a position in the vertical direction on the image.

As shown in FIG. 35, for example, a detection element that is a CCD converts inputted light into electrical charge during a period corresponding to the shutter time, and stores the converted electrical charge. The amount of electrical charge is substantially proportional to the intensity of the inputted light and the time for which the light is inputted. The detection element sequentially adds the electrical charge converted from the inputted light to the already stored electrical charge, during the period corresponding to the shutter time. That is, the detection element integrates inputted light during the period corresponding to the shutter time, and stores the electrical charge corresponding to the amount of integrated light. It can be also said that the detection element has an integral effect with respect to time.

The electrical charge stored in the detection element is converted into a voltage value by an unillustrated circuit, and the voltage value is further converted into a pixel value such as digital data and outputted. Therefore, each individual pixel value outputted from the sensor 391 has a value projected onto a one-dimensional space, which is a result of integrating a given portion of an object corresponding to the foreground or the background which has a spatial spread, with respect to the shutter time.

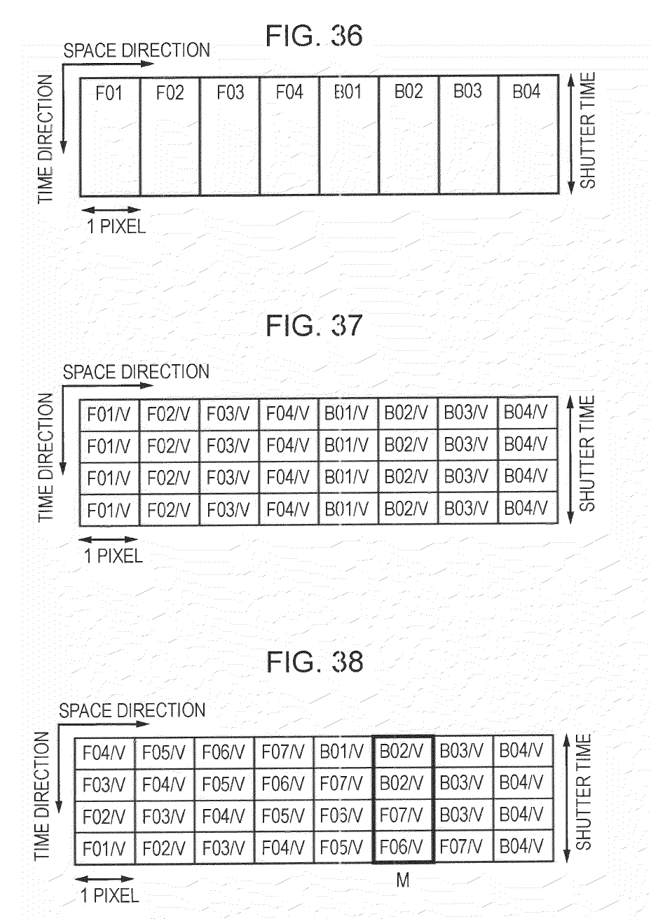

FIG. 36 illustrates a model diagram obtained by expanding in the time direction the pixel values of pixels aligned adjacent to each other, in an image obtained by capturing an object corresponding to the foreground that is stationary and an object corresponding to the background that is stationary. For example, as pixels aligned adjacent to each other, pixels arranged on one line of the screen can be selected.

The pixel values indicated by F01 through F04 shown in FIG. 36 are the pixel values of pixels corresponding to the object in the foreground that is stationary. The pixel values indicated by B01 through B04 shown in FIG. 36 are the pixel values of pixels corresponding to the object in the background that is stationary.

In the vertical direction in FIG. 36, time elapses from the top to the bottom in the drawing. The position at the top side of the rectangle in FIG. 36 corresponds to the time at which the sensor 391 starts converting inputted light into electrical charge, and the position at the bottom side of the rectangle in FIG. 36 corresponds to the time at which the sensor 391 finishes the conversion of the inputted light into the electrical charge. That is, the distance from the top side to the bottom side of the rectangle in FIG. 36 corresponds to the shutter time.

In the following, a case where the shutter speed and the frame interval are the same will be described as an example.

The transverse direction in FIG. 36 corresponds to the space direction X. More specifically, in the example shown in FIG. 36, the distance from the left side of the rectangle indicated by “F01” in FIG. 36 to the right side of the rectangle indicated by “B04” corresponds to eight times the pitch of pixels, that is, an interval of eight contiguous pixels.

When the object in the foreground and the object in the background are stationary, light inputted to the sensor 391 does not change during the period corresponding to the shutter time.

Here, the period corresponding to the shutter time is split into two or more periods of the same length. For example, if the number of virtual splits is four, the model diagram shown in FIG. 36 can be represented as the model shown in FIG. 37. The number of virtual splits is set in correspondence to the motion amount v of the object corresponding to the foreground within the shutter time, or the like. For example, the number of virtual splits is set to four in correspondence to a motion amount v of four, and the period corresponding to the shutter time is split in four.

The uppermost line in the drawing corresponds to the first split period after the shutter opens. The second line in the drawing corresponds to the second split period after the shutter opens. The third line in the drawing corresponds to the third split period after the shutter opens. The fourth line in the drawing corresponds to the fourth split period after the shutter opens.

In the following, the shutter time split in correspondence to the motion amount v is also referred to as shutter time/v.

When an object corresponding to the foreground is stationary, light inputted to the sensor 391 does not change, so a foreground component F01/v is equal to a value obtained by dividing the pixel value F01 by the number of virtual splits. Similarly, when an object corresponding to the foreground is stationary, a foreground component F02/v is equal to a value obtained by dividing the pixel value F02 by the number of virtual splits, a foreground component F03/v is equal to a value obtained by dividing the pixel value F03 by the number of virtual splits, and a foreground component F04/v is equal to a value obtained by dividing the pixel value F04 by the number of virtual splits.

When an object corresponding to the background is stationary, light inputted to the sensor 391 does not change, so a background component B01/v is equal to a value obtained by dividing a pixel value B01 by the number of virtual splits. Similarly, when an object corresponding to the background is stationary, a background component B02/v is equal to a value obtained by dividing a pixel value B02 by the number of virtual splits, B03/v is equal to a value obtained by dividing a pixel value B03 by the number of virtual splits, and B04/v is equal to a value obtained by dividing a pixel value B04 by the number of virtual splits.

That is, when an object corresponding to the foreground is stationary, light inputted to the sensor 391 and corresponding to the foreground object does not change during the period corresponding to the shutter time. Accordingly, the foreground component F01/v corresponding to the first shutter time/v after the shutter opens, the foreground component F01/v corresponding to the second shutter time/v after the shutter opens, the foreground component F01/v corresponding to the third shutter time/v after the shutter opens, and the foreground component F01/v corresponding to the fourth shutter time/v after the shutter opens become the same value. F02/v through F04/v also have a relationship similar to F01/v.

When an object corresponding to the background is stationary, light inputted to the sensor 391 and corresponding to the background object does not change during the period corresponding to the shutter time. Accordingly, the background component B01/v corresponding to the first shutter time/v after the shutter opens, the background component B01/v corresponding to the second shutter time/v after the shutter opens, the background component B01/v corresponding to the third shutter time/v after the shutter opens, and the background component B01/v corresponding to the fourth shutter time/v after the shutter opens become the same value. B02/v through B04/v also have a relationship.

Next, a description will be given of a case where an object corresponding to the foreground moves and an object corresponding to the background is stationary.

FIG. 38 is a model diagram obtained by expanding in the time direction the pixel values of pixels on one line, including a covered background area (an area that is, as opposed to the foreground area, a mixed area of foreground components and background components which is at a position corresponding to the front end portion in the travel direction of the object in the foreground, and where the background components are covered up by the foreground in accordance with the elapse of time), in a case where an object corresponding to the foreground moves to the right side in the drawing. In FIG. 38, the motion amount v of the foreground is four. Since one frame is a short period, it can be assumed that the object corresponding to the foreground is a rigid body and moves at a constant velocity. In FIG. 38, the image of the object corresponding to the foreground moves in such a way that, with a given frame taken as a reference, the image is displayed four pixels to the right side in the next frame.

In FIG. 38, the leftmost pixel through the fourth pixel from the left belong to a foreground area. In FIG. 38, the fifth to seventh pixels from the left belong to a mixed area that is the covered background area. In FIG. 38, the rightmost pixel belongs to a background area.

Since the object corresponding to the foreground is moving so as to cover up the object corresponding to the background with the elapse of time, components contained in the pixel values of pixels belonging to the covered background area change from background components to foreground components at a certain point in time within the period corresponding to the shutter time.

For example, the pixel value M enclosed by a thick frame in FIG. 38 is represented by Equation (39).

M=B02/v+B02/v+F07/v+F06/v (39)

For example, since the fifth pixel from the left contains one background component corresponding to the shutter time/v, and contains three foreground components corresponding to the shutter time/v, the mixing ratio α (proportion occupied by foreground components in the value of one pixel that is the sum of foreground components and background components) of the fifth pixel from the left is ¼. Since the sixth pixel from the left contains two background components corresponding to the shutter time/v, and contains two foreground components corresponding to the shutter time/v, the mixing ratio α of the sixth pixel from the left is ½. Since the seventh pixel from the left contains three background components corresponding to the shutter time/v, and contains one foreground component corresponding to the shutter time/v, the mixing ratio α of the seventh pixel from the left is ¾.

Since it can be assumed that the object corresponding to the foreground is a rigid body, and moves at a constant velocity such that the foreground image is displayed four pixels to the right side in the next frame, for example, the foreground component F07/v of the fourth pixel from the left in FIG. 38 in the first shutter time/v after the shutter opens is equal to the foreground component of the fifth pixel from the left in FIG. 38 corresponding to the second shutter time/v after the shutter opens. Similarly, the foreground component F07/v is equal to each of the foreground component of the sixth pixel from the left in FIG. 38 corresponding to the third shutter time/v after the shutter opens, and the foreground component of the seventh pixel from the left in FIG. 38 corresponding to the fourth shutter time/v after the shutter opens.

Since it can be assumed that the object corresponding to the foreground is a rigid body, and moves at a constant velocity such that the foreground image is displayed four pixels to the right side in the next frame, for example, the foreground component F06/v of the third pixel from the left in FIG. 38 in the first shutter time/v after the shutter opens is equal to the foreground component of the fourth pixel from the left in FIG. 38 corresponding to the second shutter time/v after the shutter opens. Similarly, the foreground component F06/v is equal to each of the foreground component of the fifth pixel from the left in FIG. 38 corresponding to the third shutter time/v after the shutter opens, and the foreground component of the sixth pixel from the left in FIG. 38 corresponding to the fourth shutter time/v after the shutter opens.

Since it can be assumed that the object corresponding to the foreground is a rigid body, and moves at a constant velocity such that the foreground image is displayed four pixels to the right side in the next frame, for example, the foreground component F05/v of the second pixel from the left in FIG. 38 in the first shutter time/v after the shutter opens is equal to the foreground component of the third pixel from the left in FIG. 38 corresponding to the second shutter time/v after the shutter opens. Similarly, the foreground component F05/v is equal to each of the foreground component of the fourth pixel from the left in FIG. 38 corresponding to the third shutter time/v after the shutter opens, and the foreground component of the fifth pixel from the left in FIG. 38 corresponding to the fourth shutter time/v after the shutter opens.

Since it can be assumed that the object corresponding to the foreground is a rigid body, and moves at a constant velocity such that the foreground image is displayed four pixels to the right side in the next frame, for example, the foreground component F04/v of the leftmost pixel in FIG. 38 in the first shutter time/v after the shutter opens is equal to the foreground component of the second pixel from the left in FIG. 38 corresponding to the second shutter time/v after the shutter opens. Similarly, the foreground component F04/v is equal to each of the foreground component of the third pixel from the left in FIG. 38 corresponding to the third shutter time/v after the shutter opens, and the foreground component of the fourth pixel from the left in FIG. 38 corresponding to the fourth shutter time/v after the shutter opens.

Since the foreground area corresponding to a moving object contains motion blur as described above, the foreground area can be also referred to as distortion area.

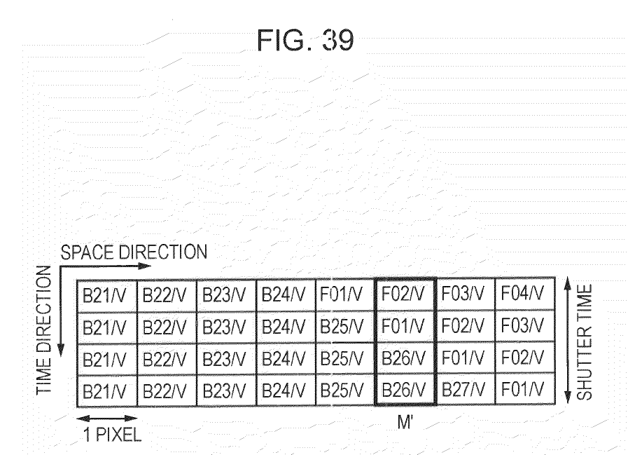

FIG. 39 is a model diagram obtained by expanding in the time direction the pixel values of pixels on one line, including an uncovered background area (an area that is, as opposed to the foreground, a mixed area of foreground components and background components which is at a position corresponding to the rear end portion in the travel direction of the object in the foreground, and where the background components appear in correspondence to the elapse of time), in a case where the foreground moves to the right side in the drawing. In FIG. 39, the motion amount v of the foreground is four. Since one frame is a short period, it can be assumed that the object corresponding to the foreground is a rigid body and is moving at a constant velocity. In FIG. 39, with a given frame taken as a reference, the image of the object corresponding to the foreground moves four pixels to the right side in the next frame.

In FIG. 39, the leftmost pixel through the fourth pixel from the left belong to a background area. In FIG. 39, the fifth to seventh pixels from the left belong to a mixed area that is the uncovered background area. In FIG. 39, the rightmost pixel belongs to a foreground area.

Since the object corresponding to the foreground which covers up the object corresponding to the background moves so as to be removed from the front of the object corresponding to the background with the elapse of time, components contained in the pixel values of pixels belonging to the uncovered background area change from foreground components to background components at a certain point in time within the period corresponding to the shutter time.

For example, the pixel value M' enclosed by a thick frame in FIG. 39 is represented by Equation (40).

M′=F02/v+F01/v+B26/v+B26/v (40)

For example, since the fifth pixel from the left contains three background components corresponding to the shutter time/v, and contains one foreground component corresponding to the shutter time/v, the mixing ratio α of the fifth pixel from the left is ¾. Since the sixth pixel from the left contains two background components corresponding to the shutter time/v, and contains two foreground components corresponding to the shutter time/v, the mixing ratio α of the sixth pixel from the left is ½. Since the seventh pixel from the left contains one background components corresponding to the shutter time/v, and contains three foreground components corresponding to the shutter time/v, the mixing ratio α of the seventh pixel from the left is ¼.

By further generalizing Equation (39) and Equation (40), the pixel value M is represented by Equation (41).

$$\begin{matrix}[ Eq . 19 ] & \\ M = α \cdot B + {\sum }_{i} {F}_{i} / v & ( 41 )\end{matrix}$$

Here, α is a mixing ratio. B represents a pixel value of the background, and Fi/v represents a foreground component.

Since it can be assumed that the object corresponding to the foreground is a rigid body and moves at a constant velocity, and the motion amount v is four, for example, the foreground component F01/v of the fifth pixel from the left in FIG. 39 in the first shutter time/v after the shutter opens is equal to the foreground component of the sixth pixel from the left in FIG. 39 corresponding to the second shutter time/v after the shutter opens. Similarly, F01/v is equal to each of the foreground component of the seventh pixel from the left in FIG. 39 corresponding to the third shutter time/v after the shutter opens, and the foreground component of the eighth pixel from the left in FIG. 39 corresponding to the fourth shutter time/v after the shutter opens.

Since it can be assumed that the object corresponding to the foreground is a rigid body and moves at a constant velocity, and the number of virtual splits is four, for example, the foreground component F02/v of the sixth pixel from the left in FIG. 39 in the first shutter time/v after the shutter opens is equal to the foreground component of the seventh pixel from the left in FIG. 39 corresponding to the second shutter time/v after the shutter opens. Similarly, the foreground component F02/v is equal to the foreground component of the eighth pixel from the left in FIG. 39 corresponding to the third shutter time/v after the shutter opens.

Since it can be assumed that the object corresponding to the foreground is a rigid body and moves at a constant velocity, and the number of virtual splits is four, for example, the foreground component F03/v of the seventh pixel from the left in FIG. 39 in the first shutter time/v after the shutter opens is equal to the foreground component of the eighth pixel from the left in FIG. 39 corresponding to the second shutter time/v after the shutter opens.

While in the description of FIG. 37 through FIG. 39 it has been described that the number of virtual splits is four, the number of virtual splits corresponds to the motion amount v. Generally, the motion amount v corresponds to the moving speed of an object corresponding to the foreground. For example, if an object corresponding to the foreground is moving so as to be displayed four pixels to the right side in the next frame with a given frame taken as a reference, the motion amount v is regarded as four. The number of virtual splits is set to four in correspondence to the motion amount v. Similarly, for example, when an object corresponding to the foreground is moving so as to be displayed six pixels to the left side in the next frame with a given frame taken as a reference, the motion amount v is regarded as six, and the number of virtual splits is set to six.

In the case of generating an image to which noise of motion blur is added, noise can be added to the motion amount v of Equation (41) described above. That is, a motion amount v_{swn} to which noise SWNv is added is represented by the following equation.

v_{swn}=v+SWNv (42)

Then, Equation (41) can be rewritten as follows, and each pixel value M is computed on the basis of the following equation.

$$\begin{matrix}[ Eq . 20 ] & \\ {M}_{swn} = α \cdot B + {\sum }_{i} {F}_{i} / {v}_{swn} & ( 43 )\end{matrix}$$

In this case as well, as indicated by the following equation, the noise SWN_{V} is the sum of a component SWNᵥ(frame) that varies on a frame-by-frame basis, and a component SWNᵥ(pixel) that varies on a pixel-by-pixel basis.

SWN_{V}=SWNᵥ(frame)+SWNᵥ(pixel) (44)

Let the noise SWN_{V} be represented by Equation (23) described above. Then, letting each component that varies on a frame-by-frame basis be RᵥΣmseqᵥ[m] (frame), and each component that varies on a pixel-by-pixel basis be RᵥΣmseqᵥ [m] (pixel), the noise SWN_{V} is represented by the following equation.

SWNᵥ=RᵥΣmseqᵥ[m](frame)+RᵥΣmseqᵥ[m](pixel) (45)

Then, the coefficient Rᵥ in Equation (45) is determined in accordance with a noise parameter N.

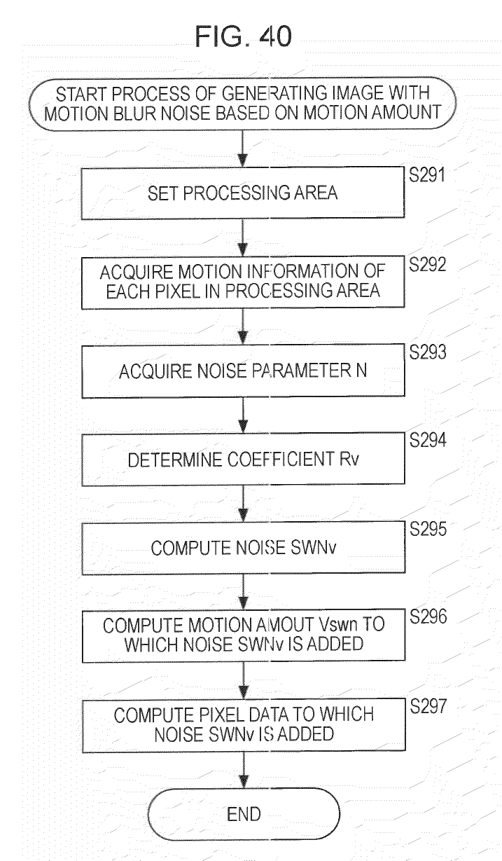

A procedure for the process of generating an image with motion blur noise based on motion amount is as shown in the flowchart in FIG. 40.

In step S291, the setting unit 331 sets an area specified by the user as a processing area. In this case, a part or the entirety of an image can be set as the processing area. This process can be omitted in a case where the entirety of an image is always processed. In step S292, the acquiring unit 332 acquires motion information of each pixel in the processing area set in step S291. The motion amount v is included in this motion information.

In step S293, the acquiring unit 332 acquires a noise parameter N specified by the user. In step S294, the determining unit 333 determines the coefficient Rᵥ in Equation (45) on the basis of the acquired noise parameter N. In step S295, the computing unit 334 computes noise SWNᵥ. That is, on the basis of the coefficient Rv determined in step S294, the noise SWN_{V} is computed in accordance with the coefficient Rv.

In step S296, the computing unit 334 computes the motion amount v_{swn} to which the noise SWN_{V} is added. That is, the motion amount v_{swn}, to which the noise SWNᵥ computed in step S295 is added is computed in accordance with Equation (42). This motion amount v_{swn} to which the noise SWNᵥ is added is outputted to the blur adding unit 311, as a parameter that gives noise in a blur model.

In step S297, in the set processing area, the computing unit 353 of the blur adding unit 311 computes pixel data to which the noise SWN_{V} is added. Specifically, a pixel value M_{swn} is computed on the basis of Equation (43), by using the mixing ratio α, the pixel value B of the background, and the pixel value Fi of the foreground that are supplied together with parent image data, and the motion amount v_{swn} to which the computed noise SWNv is added.

In this case as well, as in the case described above, it is possible to generate an image having an effect of fluctuating naturally.

Next, a description will be given of a case where an image is generated by adding noise to a direction of motion (that is, an angle).

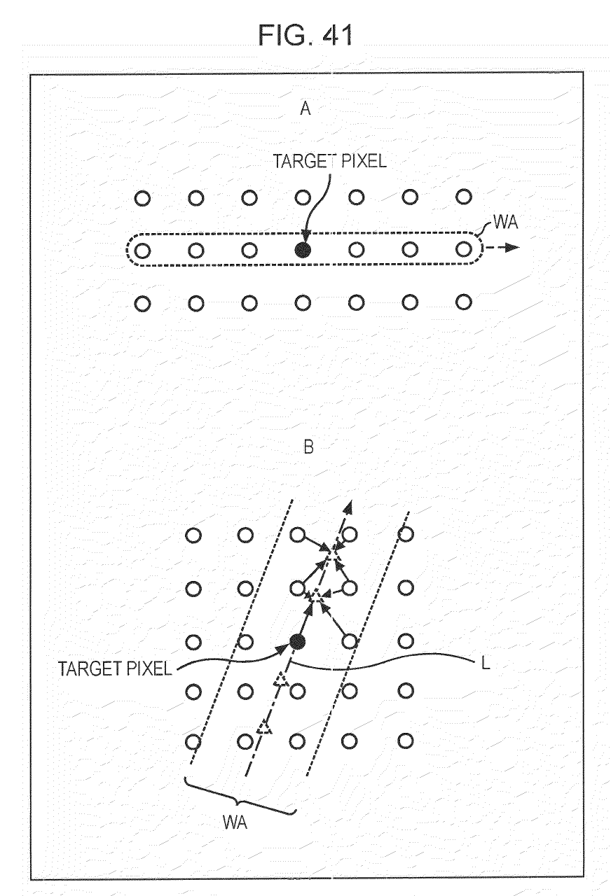

As shown in A of FIG. 41, in a case where the direction of motion is the horizontal direction, the pixel values of the other pixels within a processing area WA on a line on which a target pixel as a target is positioned are weighted by a predetermined coefficient, and a value obtained by summing the resulting products is added as a blur component to the pixel value of the target pixel. In a case where the direction of motion is the vertical direction, the pixel values of the other pixels within the processing area WA on a vertical line on which a target pixel as a target is positioned are weighted by a predetermined coefficient, and a value obtained by summing the resulting products is added as a blur component to the pixel value of the target pixel.

As shown in B of FIG. 41, in a case where the direction of motion is an oblique direction, a range of a predetermined width centered about a line L along the direction of motion on which a target pixel as a target is positioned is set as the processing area WA. Then, interpolated pixels are computed on the oblique line L, at positions spaced by the same distance as the pitch of pixels in the horizontal and vertical directions.

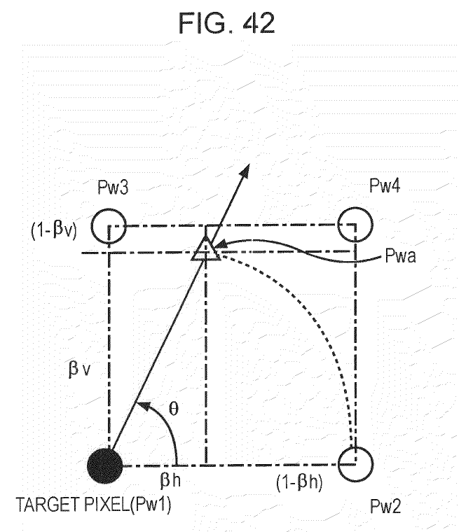

FIG. 42 illustrates the principle of computation of an interpolated pixel. As shown in the drawing, a pixel value DPwa at an interpolation position Pwa is computed on the basis of the following equation from the pixel values DPw1 through DPw4 at four neighboring positions Pw1 to Pw4 closest to the position Pwa.

$$DPwa = \{ ( 1 - β h ) ( 1 - β v ) \text{/} v \} DPw 1 + \{ ( β h ) ( 1 - β v ) \text{/} v \} DPw 2 + \{ ( 1 - β h ) ( β v ) \text{/} v \} DPw 3 + \{ ( β h ) ( β v ) \text{/} v \} DPw 4 \qquad ( 46 )$$

In Equation (46), supposing that θ is the angle with respect to the x axis on the line L of the direction of motion, βh and βv represent cos θ and sin ƒ, respectively.

Noise with respect to the angle θ (direction of motion) as blur data is added by being decomposed with respect to βh, βv. That is, letting noises with respect to βh, βPv as blur data be SWN_{βh}, SWN_{βv}, respectively, βhswn, βvswn as βh, βv after noise addition are respectively represented by the following equations.

βhswn=βh+SWN_{βh}

βvswn=βv+SWN_{βv} (47)

Let the noises SWN_{βh}, SWN_{βv} be represented by Equation (23) described above. Then, letting each component that is varied on a frame-by-frame basis be R_{βh}Σmseq_{βh}[m] (frame), R_{βv}Σmseq_{βv} [m] (frame), and each component that is varied on a pixel-by-pixel basis be R_{βh}ρmseq_{βh}[m] (pixel), R_{βv}Σmseq_{βv}[m](pixel), the noises SWN_{βh}, SWN_{βv} are represented by the following equations.

SWN_{βh}=R_{βh}Σmseq_{βh}[m](frame)+R_{βh}Σmseq_{βh}[m](pixel)

SWN_{βv}=R_{βv}Σmseq_{βv}[m](frame)+R_{βv}Σmseq_{βv}[m](pixel) (48)

Therefore, a pixel value DPwaswn at the interpolation position Pwa to which the noises SWN_{βh}, SWN_{βv} are added is represented by the following equation. This equation means that noise is added to the position of an interpolated pixel in the case of computing the pixel value DPwa at the interpolation position Pwa.

$$DPwaswn = \{ ( 1 - β hswn ) ( 1 - β vswn ) \text{/} v \} DPw 1 + \{ ( β hswn ) ( 1 - β vswn ) \text{/} v \} DPw 2 + \{ ( 1 - β hswn ) ( β vswn ) \text{/} v \} DPw 3 + \{ ( β hswn ) ( β vswn ) \text{/} v \} DPw 4 \qquad ( 49 )$$

The pixel value DPwswn of a target pixel obtained by adding noise to the pixel value DPw1 of a target pixel is computed by the following equation. wᵢ is a weighting coefficient for each interpolated pixel, and is selected and determined on the basis of a blur parameter P.

$$\begin{matrix}[ Eq . 21 ] & \\ {DP}_{wswn} = {DP}_{w 1} + {\sum }_{i} {w}_{i} \cdot {DP}_{waswn} & ( 50 )\end{matrix}$$

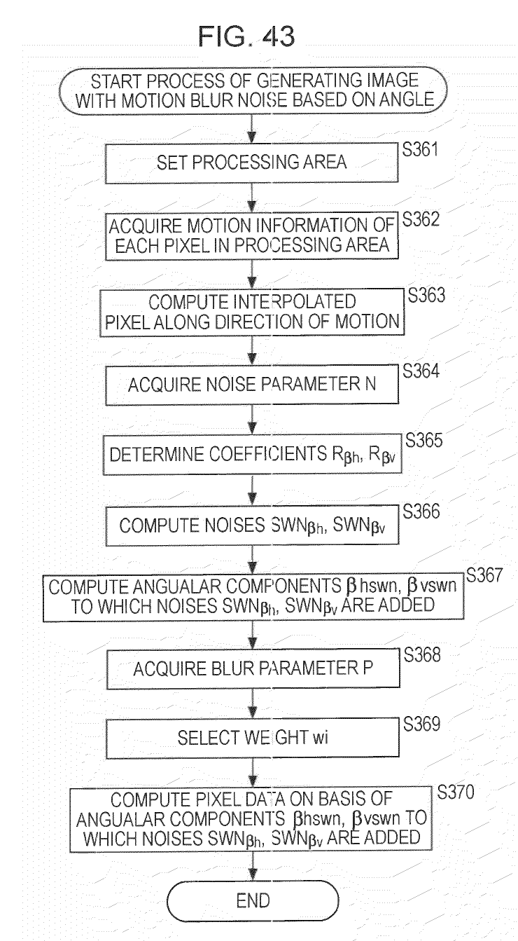

Next, referring to the flowchart in FIG. 43, a description will be given of the process of generating an image with motion blur noise based on direction of motion, that is, an angle.

In step S361, the setting unit 331 sets a processing area on the basis of a user's instruction. In this case, the user can set a part or the entirety of an image as the processing area.

This process can be omitted in a case where the entirety of an image is always processed. In step S362, the acquiring unit 332 acquires motion information of each pixel in the processing area. In addition to the motion amount v, information indicating the direction of motion is included in this motion information.

In step S363, the computing unit 334 computes an interpolated pixel along the direction of motion. That is, the pixel value DPwa is computed on the basis of Equation (46). In step S364, the acquiring unit 332 acquires a noise parameter N on the basis of an input from the user. In step S365, the determining unit 333 determines the coefficients R_{βh}, R_{βv} of the noises SWN_{βh}, SWN_{βv} in Equation (48).

In step S366, the computing unit 334 computes the noises SWN_{βh}, SWN_{βv} on the basis of Equation (48). In step S367, the computing unit 334 computes angular components βhswn, βvswn to which the noises SWN_{βh}, SWN_{βv} are added, on the basis of Equation (47). The angular components βhswn, βvswn to which the noises SWN_{βh}, SWN_{βv} are added are outputted to the blur adding unit 311 as parameters that give noise in a blur model.

In step S368, the acquiring unit 351 of the blur adding unit 311 acquires a blur parameter P on the basis of an input from the user. In step S369, on the basis of the acquired blur parameter P, the selecting unit 352 selects a corresponding weight wᵢ from among weights wᵢ stored in advance. In step S370, the computing unit 353 computes pixel data on the basis of the angular components βhswn, βvswn to which the noises SWN_{βh}, SWN_{βv} are added. That is, the pixel value DPwswn is computed on the basis of Equation (50).

In this case as well, as in the case described above, it is possible to generate an image having an effect of fluctuating naturally.

Incidentally, in the case of generating a blurred image, two or more of the plurality of methods mentioned above may be combined as appropriate.

Also, each of the above-mentioned noises SWN (the noises SWNd, SWNsx, SWNsy, SWNk(x, y), SWNl(x, y), SWNₚ, SWNv, SWN_{βh}, SWN_{βv}) can be also represented by the following equation, other than Equation (23):

SWN=a+b·rand (51)

−1.0≦rand≦1.0

where a is an offset, and b is a gain. rand is a function that generates a pseudo-random number.

Alternatively, the noise SWN can be also represented by the following equation.

SWN=a(d)+b(d)·rand (52)

This equation is a function of the offset a and the gain b in Equation (51) with respect to d.

The image data to which the noise has been added in the blur adding unit 311 further undergoes addition of noise as required in the noise adding unit 313, and then is supplied to an unillustrated device as image data with added effect.

This image data is supplied to the tap constructing unit 314, and used for a learning process. Also, information necessary for learning (the same information as the information supplied to the blur adding unit 311) is also supplied to the tap constructing unit 315 from the noise adding unit 312.

Of the information supplied to the blur adding unit 311 and the noise adding units 312, 313, necessary information is also supplied to the prediction coefficient computing unit 318. That is, a noise parameter N, a noise parameter Ni, a blur parameter P, and motion information (amount of motion and direction) are supplied to the prediction coefficient computing unit 318.

Since the learning process performed in the image generating device 301 in FIG. 20 or the image generating device 400 in FIG. 21 is similar to that in the case of the learning device 1 in FIG. 3 or the learning device 1 in FIG. 14, and description thereof is omitted to avoid repetition. Through this process, a prediction coefficient for generating an image corrected for fluctuation from an image with fluctuation added thereto is obtained.

While the class to be used in computing a prediction coefficient is arbitrary, for example, a class D corresponding to a blur parameter P can be determined on the basis of the following equation.

D=(a+A)×Nmax+(n+N) (53)

a in Equation (53) mentioned above represents an x-coordinate component of a motion vector in a specified area, and n represents a y-coordinate component. Also, A represents an x-coordinate component of an offset value inputted by the user, and N represents a y-coordinate component. Nmax means the total number of classes of the y-coordinate component. Blur parameters stored in association with image data are the values ((a+A), (n+N)) in Equation (53). Therefore, the class D can be computed by applying the values of blur parameters ((a+A), (n+N)) to Equation (53) mentioned above.

Accordingly, the final class total_class can be determined by the classification unit 316 as represented by the following equation, by combining a class W of a waveform pattern and the class D of a blur parameter, for example. Incidentally, size_w represents the number of classes of the class W.

total_class=classW+classD×size_{—}w (54)

Classification can be also performed on the basis of the motion amount v or the direction of motion (angle θ). In that case, classification can be also performed by extracting a class tap from an image in accordance with a motion amount and the size of an angle, and performing 1-bit ADRC on the class tap, or classification can be performed on the basis of a motion amount and an angle themselves.

Also, for example, a class classVc using the integer of the motion amount v as it is, and a class classVdiff classifying differential values between a target pixel and eight adjacent pixels in the surrounding thereof into three classes of positive, negative, and the same value, can be combined as indicated by the following equation. Incidentally, i corresponds to each adjacent pixel.

total_class=classVc+classVdiff×size_{—}VcclassVdiff=Σᵢ{classVdiff_{—}i×3ⁱ} (55)

With 1 motion to 30 motions as the target, size_Vc in Equation (55) is 30.

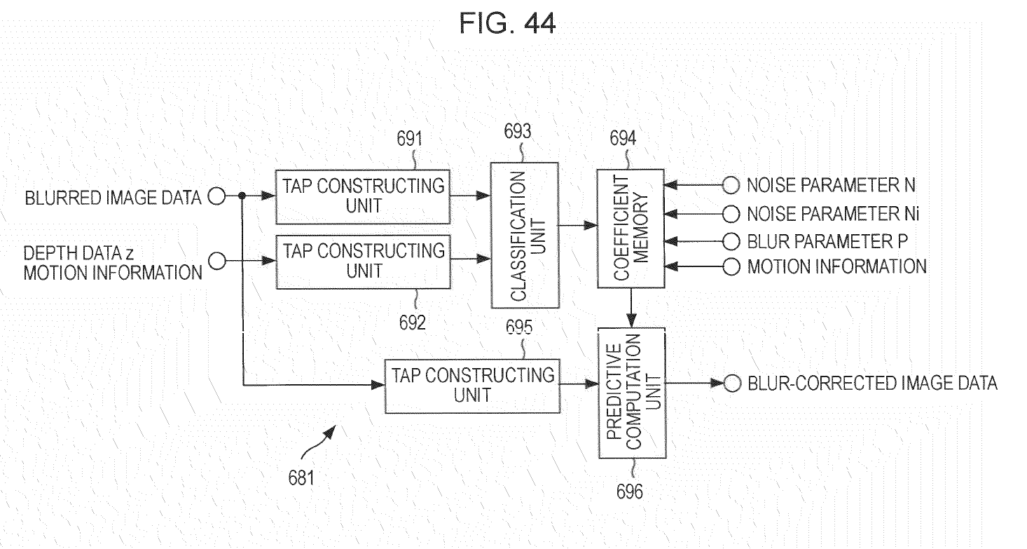

FIG. 44 is a block diagram showing the configuration of an embodiment of a prediction device that corrects an image in which blur is contained, by using the prediction coefficient generated through learning by the image generating device 301 in FIG. 20. This prediction device 681 is basically configured similarly to the prediction device 81 in FIG. 9.

That is, a tap constructing unit 691, a tap constructing unit 692, a classification unit 693, a coefficient memory 694, a tap constructing unit 695, and a predictive computation unit 696 included in the prediction device 681 in FIG. 44 have functions basically similar to the tap constructing unit 91, the tap constructing unit 92, the classification unit 93, the coefficient memory 94, the tap constructing unit 95, and the predictive computation unit 96 included in the prediction device 81 in FIG. 9.

It should be noted, however, that not only depth data z but also motion information is inputted to the tap constructing unit 692. Motion information is also inputted to the coefficient memory 694, other than a noise parameter Ni and a blur parameter P. Also, instead of a noise parameter Nz, a noise parameter N is inputted.

This prediction process by the prediction device 681 is similar to that in the case shown in FIG. 10, except only that the information used for the process is different, and description thereof is omitted. It should be noted, however, that in this case, in step S32 in FIG. 10, a class tap is constructed from depth data z or motion information in the tap constructing unit 692.

In step S35, on the basis of a class supplied from the classification unit 693, motion information, and a noise parameter N, a noise parameter Ni, and a blur parameter P that are specified by the user, a coefficient memory 701 reads a prediction coefficient wₙ corresponding to the class, the motion information, the noise parameter N, the noise parameter Ni, and the blur parameter P from among prediction coefficients wₙ that have been already stored, and provides the prediction coefficient wₙ to the predictive computation unit 696.

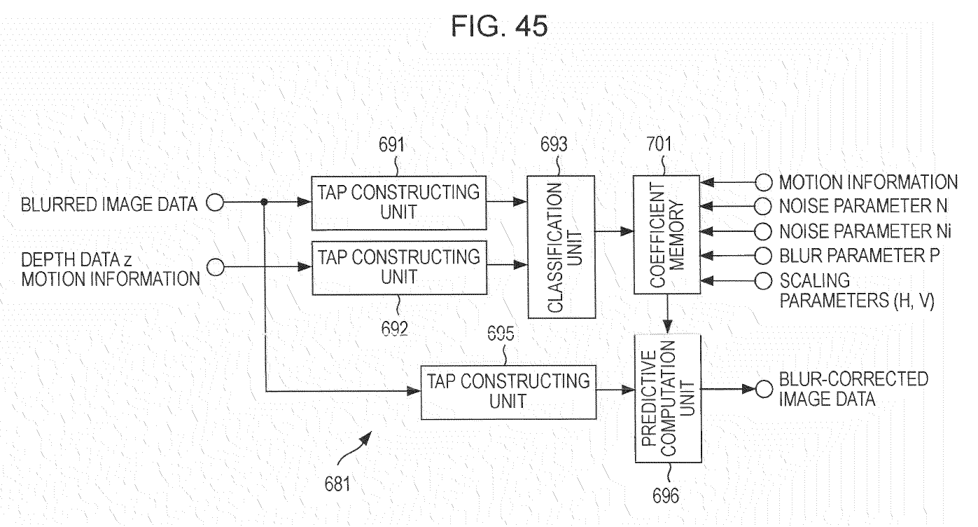

FIG. 45 is a block diagram showing the configuration of an embodiment of a prediction device that corrects an image in which blur is contained, by using the prediction coefficient generated through learning by the image generating device 400 in FIG. 21. This prediction device 681 is basically configured similarly to the prediction device 81 in FIG. 13.

That is, the tap constructing unit 691, the tap constructing unit 692, the classification unit 693, the coefficient memory 701, the tap constructing unit 695, and the predictive computation unit 696 included in the prediction device 681 in FIG. 45 have functions basically similar to the tap constructing unit 91, the tap constructing unit 92, the classification unit 93, the coefficient memory 111, the tap constructing unit 95, and the predictive computation unit 96 included in the prediction device 81 in FIG. 13.

It should be noted, however, that not only depth data z but also motion information is inputted to the tap constructing unit 692. Motion information is also inputted to the coefficient memory 701, other than a noise parameter Ni, a blur parameter P, and scaling parameters (H, V). Also, instead of a noise parameter Nz, a noise parameter N is inputted.

This prediction process by the prediction device 681 is similar to that in the case shown in FIG. 10, except only that the information used for the process is different, and description thereof is omitted. It should be noted, however, that in this case, in step S32 in FIG. 10, a class tap is constructed from depth data z or motion information in the tap constructing unit 692.

In step S35, on the basis of a class supplied from the classification unit 693, motion information, and a noise parameter N, a noise parameter Ni, a blur parameter P, and scaling parameters (H, V) that are specified by the user, the coefficient memory 701 reads a prediction coefficient wₙ corresponding to the class, the motion information, the noise parameter N, the noise parameter Ni, the blur parameter P, and the scaling parameters (H, V) from among prediction coefficients wₙ that have been already stored, and provides the prediction coefficient wₙ to the predictive computation unit 696.

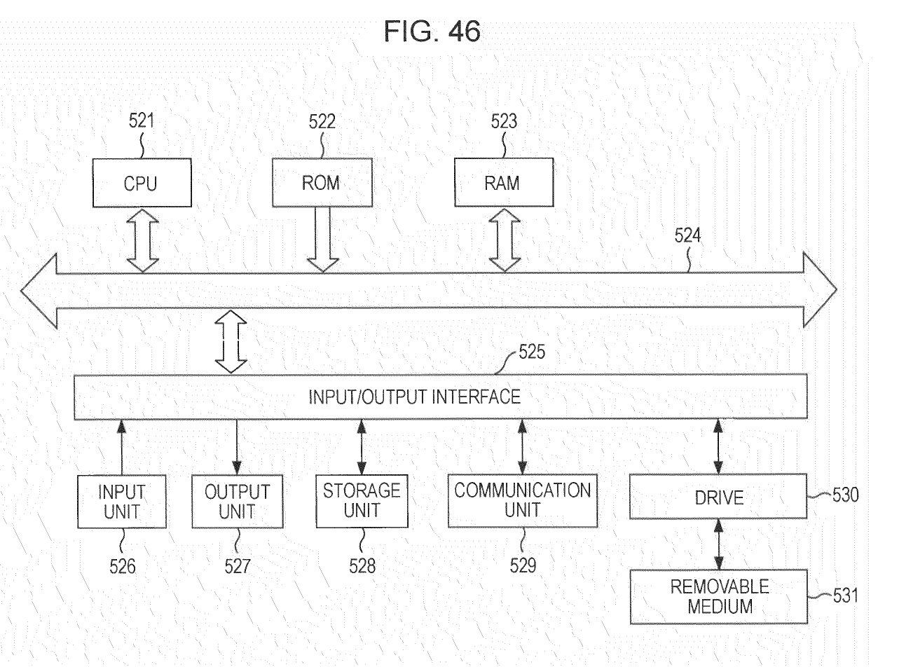

FIG. 46 is a block diagram showing an example of the configuration of a personal computer that executes the series of processes described above by a program. A CPU (Central Processing Unit) 521 executes various processes in accordance with a program stored in a ROM (Read Only Memory) 522 or a storage unit 528. A program executed by the CPU 521, data, and the like are stored in a RAM (Random Access Memory) 523 as appropriate. The CPU 521, the ROM 522, and the RAM 523 are connected to each other via a bus 524.

The CPU 521 is also connected with an input/output interface 525 via the bus 524. The input/output interface 525 is connected with an input unit 526 constituted by a keyboard, a mouse, a microphone, or the like, and an output unit 527 constituted by a display, a speaker, or the like. The CPU 521 executes various processes in accordance with a command inputted from the input unit 526. Then, the CPU 521 outputs the processing result to the output unit 527.

The storage unit 528 connected to the input/output interface 525 is configured by, for example, a hard disk, and stores a program executed by the CPU 521 and various data. A communication unit 529 communicates with an external device via a network such as the Internet or local area network. Also, the communication unit 529 may be configured to acquire a program and stores the program onto the storage unit 528.

When a removable medium 531 such as a magnetic disk, an optical disk, a magneto-optical disk, or a semiconductor memory is mounted, a drive 530 connected to the input/output interface 525 drives the removable medium 531, and acquires a program, data, and the like stored therein. The acquired program and data are transferred to the storage unit 528 as required, and stored therein.

Incidentally, in this specification, steps describing a program recorded on a recording medium include, of course, processes that are performed time sequentially in the described order, but also processes that are not necessarily processed time sequentially but executed in a parallel fashion or independently.

Also, embodiments of the present invention are not limited to the above-described embodiments, and various modifications are possible without departing from the scope of the present invention.

1. A prediction coefficient computing device comprising:
blur adding means for adding blur to parent image data on the basis of blur data of a blur model to generate student image data;
image prediction tap constructing means for constructing an image prediction tap from the student image data; and
prediction coefficient computing means for computing a prediction coefficient for generating image data corresponding to the parent image data, from image data corresponding to the student image data, on the basis of the parent image data and the image prediction tap.

2. The prediction coefficient computing device according to claim 1, further comprising:
image class tap constructing means for constructing an image class tap from the student image data;
blur data class tap constructing means for constructing a blur data class tap from the blur data; and
classification means for classifying a class of the student image data on the basis of the image class tap and the blur data class tap,
wherein the prediction coefficient computing means further computes the prediction coefficient for each the classified class.

3. The prediction coefficient computing device according to claim 2, wherein:
the blur adding means adds blur to the parent image data on the basis of a characteristic according to a blur parameter specified by a user; and
the prediction coefficient computing means further computes the prediction coefficient for each the blur parameter.

4. The prediction coefficient computing device according to claim 3, further comprising blur noise adding means for adding noise to the blur data on the basis of a characteristic according to a noise parameter specified by the user, wherein:
the blur adding means adds blur to the parent image data on the basis of the blur data to which noise has been added;
the blur data class tap constructing means constructs the blur data class tap from the blur data to which noise has been added; and
the prediction coefficient computing means further computes the prediction coefficient for each the blur parameter.

5. The prediction coefficient computing device according to claim 4, further comprising blur data scaling means for scaling the blur data on the basis of a scaling parameter specified by the user, wherein:
the blur noise adding means adds noise to the scaled blur data; and
the prediction coefficient computing means further computes the prediction coefficient for each the scaling parameter.

6. The prediction coefficient computing device according to claim 4, further comprising image noise adding means for adding noise to the student image data on the basis of a characteristic according to an image noise parameter specified by the user, wherein:
the image class tap constructing means constructs the image class tap from the student image data to which noise has been added;
the image prediction tap constructing means constructs the image prediction tap from the student image data to which noise has been added; and
the prediction coefficient computing means further computes the prediction coefficient for each the image noise parameter.

7. The prediction coefficient computing device according to claim 6, further comprising image scaling means for scaling the student image data on the basis of a scaling parameter specified by the user, wherein:
the image noise adding means adds noise to the scaled student image data; and
the prediction coefficient computing means further computes the prediction coefficient for each the scaling parameter.

8. The prediction coefficient computing device according to claim 2, further comprising blur data prediction tap constructing means for constructing a blur data prediction tap from the blur data,
wherein the prediction coefficient computing means computes, for each the classified class, a prediction coefficient for generating image data corresponding to the student image data, on the basis of the parent image data, the image prediction tap, and the blur data prediction tap.

9. The prediction coefficient computing device according to claim 2, wherein the blur data is data to which noise is added.

10. A prediction coefficient computing method for a prediction coefficient computing device that computes a prediction coefficient, comprising:
adding blur to parent image data on the basis of blur data of a blur model to generate student image data, by blur adding means; and
computing a prediction coefficient for generating image data corresponding to the parent image data, from image data corresponding to the student image data, on the basis of the parent image data and the image prediction tap, by prediction coefficient computing means.

11. A program for causing a computer to execute processing including:
a blur adding step of adding blur to parent image data on the basis of blur data of a blur model to generate student image data;
an image prediction tap constructing step of constructing an image prediction tap from the student image data; and
a prediction coefficient computing step of computing a prediction coefficient for generating image data corresponding to the parent image data, from image data corresponding to the student image data, on the basis of the parent image data and the image prediction tap.

12. A recording medium on which the program according to claim 11 is recorded.

13. An image data computing device comprising:
prediction coefficient providing means for providing a prediction coefficient corresponding to a parameter that is specified by a user and is a parameter related to blurring of image data;
image prediction tap constructing means for constructing an image prediction tap from the image data; and
image data computing means for computing image data that is corrected for blurring, by applying the image prediction tap and the provided prediction coefficient to a predictive computing equation.

14. The image data computing device according to claim 13, further comprising:
image class tap constructing means for constructing an image class tap from the image data;
blur data class tap constructing means for constructing a blur data class tap from blur data; and
classification means for classifying a class of the image data on the basis of the image class tap and the blur data class tap,
wherein the prediction coefficient providing means further provides the prediction coefficient corresponding to the classified class.

15. The image data computing device according to claim 14, wherein the prediction coefficient providing means provides the prediction coefficient on the basis of a blur parameter that defines a characteristic of blur, a parameter that defines a class based on noise contained in the image data, a parameter that defines a class based on noise contained in the blur data, or motion information.

16. The image data computing device according to claim 14, wherein the prediction coefficient providing means further provides the prediction coefficient on the basis of a parameter that is specified by a user and is a parameter that defines a class based on scaling of the image data or the blur data.

17. The image data computing device according to claim 14, wherein the blur data further comprises the blur data prediction tap constructing means for constructing the blur data prediction tap from the blur data,
wherein the image data computing means computes image data that is corrected for blurring, by applying the image prediction tap, the blur data prediction tap, and the provided prediction coefficient to the predictive computing equation.

18. An image data computing method for an image data computing device that computes image data, comprising:
providing a prediction coefficient corresponding to a parameter that is specified by a user and is a parameter related to blurring of the image data, by prediction coefficient providing means;
constructing an image prediction tap from the image data by image prediction tap constructing means; and
computing image data that is corrected for blurring, by applying the image prediction tap and the provided prediction coefficient to a predictive computing equation, by image data computing means.

19. A program for causing a computer to execute processing including:
a prediction coefficient providing step of providing a prediction coefficient corresponding to a parameter that is specified by a user, and is a parameter related to blurring of image data;
an image prediction tap constructing step of constructing an image prediction tap from the image data; and
an image data computing step of computing image data that is corrected for blurring, by applying the image prediction tap and the provided prediction coefficient to a predictive computing equation.

20. A recording medium on which the program according to claim 19 is recorded.

21. An image data computing device comprising:
parameter acquiring means for acquiring a parameter;
noise computing means for computing noise of blur of a blur model on the basis of the acquired parameter; and
image data computing means for computing image data to which the noise of the blur model is added.

22. The image data computing device according to claim 21, wherein the image data computing means computes the image data by adding noise to a point spread function of blur.

23. The image data computing device according to claim 22, wherein:
the noise computing means computes depth data with noise added to depth data; and
the image data computing means adds noise to the point spread function of blur on the basis of the depth data to which noise has been added.

24. The image data computing device according to claim 22, wherein the noise computing means computes a deviation, phase, or sharpness of the point spread function of blur, or noise as a composite thereof.

25. The image data computing device according to claim 21, wherein the noise computing means computes a motion amount, a direction of motion, or noise as a composite thereof.

26. The image data computing device according to claim 25, wherein in a case of adding noise to the direction of motion, the noise computing means adds noise to a position of an interpolated pixel at the time of computing a pixel value of the interpolated pixel in the direction of motion.

27. The image data computing device according to claim 21, further comprising setting means for setting a processing area,
wherein the image data computing means adds noise with respect to image data in the set processing area.

28. An image data computing method for an image data computing device that computes image data, comprising:
acquiring a parameter by parameter acquiring means;
computing noise of blur of a blur model on the basis of the acquired parameter, by noise computing means; and
computing image data to which the noise of the blur model is added, by image data computing means.

29. A program for causing a computer to execute processing including:
a parameter acquiring step of acquiring a parameter;
a noise computing step of computing noise of blur of a blur model, on the basis of the acquired parameter; and
an image data computing step of computing image data to which the noise of the blur model is added.

30. A recording medium on which the program according to claim 29 is recorded.
